(19) United States
(12) Patent Application Publication
(10) Pub. No.: US 2016/0021921 A1
(43) Pub. Date: Jan. 28, 2016

(54) PRETERM INFANT NUTRITIONAL COMPOSITIONS CONTAINING BETA-HYDROXY-BETA-METHYLBUTYRIC ACID

(71) Applicant: ABBOTT LABORATORIES, Abbott Park,, IL (US)

(72) Inventors: Steven Davis, Galena, OH (US); Barbara Marriage, Columbus, OH (US); Christine Gallardo, New Albany, OH (US); Marti Bergana, Blacklick, OH (US); Bridget Barrett-Reis, Dublin, OH (US)

(73) Assignee: ABBOTT LABORATORIES, Abbott Park, IL (US)

(21) Appl. No.: 14/777,187

(22) PCT Filed: Mar. 14, 2014
(86) PCT No.: PCT/US2014/027534

§ 371 Date: Sep. 15, 2015

Related U.S. Application Data
(60) Provisional application No. 61/791,839, filed on Mar. 15, 2013.

(51) Int. Cl. A23L 1/305; A23C 9/20; A23L 1/29

(52) U.S. Cl. CPC A23L 1/3051; A23L 1/296; A23C 9/206; A23V 2002/00

(57) ABSTRACT

Preterm infant nutritional compositions comprising beta-hydroxy-beta-methylbutyric acid for supporting growth, accretion of lean body mass, and a healthy body composition in preterm infants are provided. The preterm infant nutritional compositions may be liquid formulas, fortifiers, and supplements. Methods for supporting growth, accretion of lean body mass, and a healthy body composition in a preterm infant are also provided. The methods include administering a preterm infant nutritional composition comprising beta-hydroxy-beta-methylbutyric acid to the preterm infant.

### CROSS REFERENCE TO RELATED APPLICATIONS

This application claims priority to and the benefit of U.S. Provisional Application No. 61/791,839, filed Mar. 15, 2013, the entire content of which is incorporated herein by reference.

### FIELD

The present disclosure relates to preterm infant nutritional compositions for preterm infants and methods of their use. The preterm infant nutritional compositions comprise beta-hydroxy-beta-methylbutyric acid, and may be in any useful form including, but not limited to liquid preterm infant formulas, fortifiers, and supplements. The disclosure further relates to methods for supporting the growth and accretion of lean body mass in a preterm infant.

### BACKGROUND

Preterm infants require protein to thrive. However, preterm infants have immature gastrointestinal tracts, which may limit their ability to tolerate, digest and absorb the nutrition that they need. For example, a preterm infant with an immature gastrointestinal tract may have difficultly converting dietary protein into the lean body mass which would allow the preterm infant to catch up to a term infant in relation to growth.

The current means by which this problem is addressed is to provide nutrients to preterm infants via infant formulas, fortifiers and supplements that are enriched in energy and nutrients including protein, fat, calcium and phosphorus. Yet this approach presents a further problem, because the intake of preterm infants is volume restricted and, in relation to term infants, preterm infants have a particularly limited ability to tolerate higher feeding volumes and higher protein and nutrient intakes.

### SUMMARY

The present disclosure generally relates to preterm infant nutritional compositions including, but not limited to, preterm infant formulas, fortifiers, supplements, and combinations thereof. The preterm infant nutritional compositions comprise beta-hydroxy-beta-methylbutyric acid (“HMB”). The preterm infant nutritional compositions may promote growth and accretion of lean body mass in preterm infants which typically have a high demand for protein synthesis for growth. Without wishing to be bound by theory, it is believed that the nutritional compositions increase lean body mass by increasing protein synthesis without inhibiting protein degradation in the muscle and other organs of the preterm infant.

It is believed that the present preterm infant nutritional compositions promote the growth and accretion of lean body mass without increasing feeding volume or requiring higher protein and/or nutrient intakes. Thus, the preterm infant nutritional compositions may be particularly useful for preterm infants during early life when feeding volumes are low.

It has further been surprisingly discovered that the use of HMB in preterm infant nutritional compositions instead of leucine to promote protein synthesis provides several advantages. First, HMB provides similar if not superior potency for stimulating protein synthesis than leucine does. Second, HMB promotes protein synthesis without increasing blood urea nitrogen, which can be an issue for certain infants. Thus, the present disclosure is directed to embodiments including, but not limited to the following.

In some embodiments, the disclosure is directed to a liquid preterm infant nutritional composition comprising HMB at from about 60 μg to about 6,000 mg per liter of the composition, wherein the formula has an energy density of from about 676 to about 1014 kcal per liter. The composition may be administered in any suitable way, for example, orally or via naso-gastric and other modes of tube-feeding.

In some embodiments, the disclosure is directed to a preterm infant nutritional composition formulated as a liquid human milk fortifier. The liquid human milk fortifiers comprise HMB at from about 60 μg to about 6,000 mg per liter of the composition, wherein the liquid fortifier has an energy density of from about 2 kcal to about 10 kcal, or from about 3 kcal to about 8 kcal, per 5 ml of the fortifier. In some embodiments, the liquid fortifier has an energy density of about 6.85 kcal per 5 ml of the fortifier. The liquid human milk fortifier can be administered in any suitable way, for example, as added to human milk and delivered orally or via naso-gastric and other modes of tube feeding.

In some embodiments, the disclosure is directed to a preterm infant nutritional composition formulated as a powdered human milk fortifier. The powdered human milk fortifiers comprise HMB at less than about 200 g, less than about 50 g, less than about 10 g, less than about 2 mg, of HMB per kilogram of the fortifier. In some embodiments, the powdered human milk fortifiers comprise from about 2 mg to about 200 g of HMB per kilogram of the fortifier, or from about 10 g to about 50 g, of HMB per kilogram of the fortifier. The powdered human milk fortifier may have an energy density of from about 200 to about 600 kcal, or from about 300 to about 500 kcal, per kilogram of the fortifier. In some embodiments, the powdered human milk fortifier may have an energy density of about 389 kcal/100 g. The powdered human milk fortifier can be administered in any suitable way, for example, as added to human milk and delivered orally or via naso-gastric and other modes of tube feeding.

In some embodiments, the disclosure is directed a preterm infant nutritional composition formulated as a liquid protein supplement. The liquid protein supplements comprise HMB at from about 60 μg to about 6,000 mg per liter of the supplement, wherein the liquid protein supplement has an energy density of from about 2 to about 10 kcal, or from about 4 to about 6 kcal, per 6 ml of the supplement. In some embodiments, the liquid protein supplement composition has an energy density of about 4 kcal per 6 ml of the supplement. The liquid protein supplement can be administered in any suitable way, for example, as added to human milk and delivered orally or via naso-gastric and other modes of tube feeding.

In some embodiments, the disclosure is directed to a method for promoting growth and accretion of lean body mass in a preterm infant, the method comprising the step of administering to the preterm infant a preterm infant nutritional composition comprising HMB at from about 60 μg per liter of the composition to about 6,000 mg per liter the composition, the composition having an energy density of from about 676 to about 1014 kcal per liter.

In some embodiments, the disclosure is directed to a method for promoting protein synthesis in a preterm infant, the method comprising the step of administering to the preterm infant a preterm infant nutritional composition comprising HMB at from about 60 μg per liter of the composition to about 6,000 mg per liter the composition, the composition having an energy density of from about 676 to about 1014 kcal per liter.

### BRIEF DESCRIPTION OF THE FIGURES

FIG. 1 shows a plot of the blood plasma concentration of HMB vs. the amount of HMB infused in piglets.

FIG. 2 shows a plot of plasma concentrations of various compounds vs. the amount of HMB infused in piglets.

FIG. 3 is a plot of amino acid concentration vs. plasma BCAA, EAA, NEAA and leucine concentrations in piglets infused with HMB or leucine.

FIG. 4 shows a plot of plasma glucose concentrations in piglets infused with HMB.

FIG. 5 shows a plot of the fractional rate of protein synthesis in skeletal muscles of piglets infused with HMB.

FIG. 6 shows a plot of the fractional protein synthesis in the lung of piglets infused with HMB.

FIG. 7 shows a plot of the fractional protein synthesis in the spleen of piglets infused with HMB.

FIG. 8 shows the protein synthesis rate in various muscles of piglets in response to infusion of HMB or leucine.

FIG. 9 shows a plot of the phosphorylation of S6K1 in muscles of piglets infused with HMB.

FIG. 10 shows a plot of the phosphorylation of 4EBP1 in muscles of piglets infused with HMB.

FIG. 11 shows a plot of the formation of the active e1F4E•e1F4G complex in muscles of piglets infused with HMB.

FIG. 12 shows a plot of the phosphorylation of elF2α in muscles of piglets infused with HMB.

FIG. 13 shows a plot of the phosphorylation of eEF2 in muscles of piglets infused with HMB.

FIG. 14 shows a plot of the expression of Atrogin-1 in muscles of piglets infused with HMB.

FIG. 15 shows a plot of the expression of MURF1 in muscles of piglets infused with HMB.

FIG. 16 shows a plot of the ratio of LC3-II/LC3-I in muscles of piglets infused with HMB.

### DETAILED DESCRIPTION

The preterm infant nutritional compositions and related methods of use as described herein may promote the growth and accretion of lean body mass in infants, particularly those with a high demand for protein synthesis for growth, such as preterm infants.

The elements or features of the various embodiments are described in detail hereinafter.

“Lean body mass” as used herein means the total mass of muscle that is present in the body.

“Premature infant” and “preterm infant” as used herein means an infant born before the thirty-seventh completed week of gestation.

“High calorie” as used herein means an energy density of from about 676 to about 1014 kcal per liter of the composition.

“Substantially free” as used herein means the selected composition or method contains or is directed to less than a functional amount of the ingredient or feature, typically less than 0.1% by weight, and also including zero percent by weight, of such ingredient or feature. The nutritional compositions and methods herein may also be “substantially free of” any optional or other ingredient or feature described herein provided that the remaining composition still contains the requisite ingredients or features as described herein.

The terms “fat,” “oil,” and “lipid” as used herein, unless otherwise specified, are used interchangeably to refer to lipid materials derived or processed from plants or animals. These terms also include synthetic lipid materials so long as such synthetic materials are suitable for oral administration to humans.

The terms “preterm infant nutritional composition,” “preterm infant formula,” “nutritional product,” and “nutritional composition,” as used herein are used interchangeably and, unless otherwise specified, refer to nutritional liquids, nutritional semi-liquids, nutritional semi-solids, and nutritional powders. The nutritional powders may be reconstituted to form a nutritional liquid, all of which comprise at least one macronutrient, which may be selected from the group consisting of fat, protein, and carbohydrate and which are suitable for oral consumption by a human.

The term “nutritional liquid,” as used herein, unless otherwise specified, refers to nutritional products in ready-to-drink liquid form, concentrated form, and nutritional liquids made by reconstituting the nutritional powders described herein prior to use.

The term “nutritional powder,” as used herein, unless otherwise specified, refers to nutritional products in flowable or scoopable form that can be reconstituted with water or another aqueous liquid prior to consumption and includes both spray dried and drymixed/dryblended powders.

The term “infant formula” as used herein refers to nutritional compositions that are designed specifically for consumption by an infant.

The term “preterm infant formula” as used herein refers to nutritional compositions that are designed specifically for consumption by a preterm infant.

The term “human milk fortifier” as used herein refers to liquid and solid nutritional compositions suitable for mixing with breast milk or preterm infant formula or infant formula for consumption by a preterm or term infant.

The term “supplement” is used interchangeably herein with “liquid protein supplement.” As used herein, unless otherwise specified, “supplement” means an extensively hydrolyzed protein composition that may be utilized to complete a feeding, make up for a deficiency, and/or to fortify the feeding for a preterm infant.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified. All numerical ranges as used herein, whether or not expressly preceded by the term “about,” are intended and understood to be preceded by that term, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Any reference to a singular characteristic or limitation of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The preterm infant nutritional compositions and methods may comprise, consist of, or consist essentially of the elements and features of the disclosure described herein, as well as any additional or optional ingredients, components, or features described herein or otherwise useful in a nutritional application.

All documents (patents, patent applications and other publications) cited in this application are incorporated herein by reference in their entirety.

### Product Form

The preterm infant nutritional compositions of the present disclosure may be administered to preterm infants. The preterm infant nutritional compositions comprise beta-hydroxy-beta-methylbutyric acid (HMB) and are capable of improving growth and accretion of lean body mass in the preterm infant. The preterm infant nutritional compositions may be formulated and administered in any suitable oral product form. Any solid, semi-solid, liquid, semi-liquid, or powder form, including combinations or variations thereof, are suitable for use herein, provided that such forms allow for safe and effective oral delivery to the individual of the ingredients as defined herein.

The preterm infant nutritional compositions of the present disclosure include any product form comprising the ingredients described herein, and which is safe and effective for oral administration. The preterm infant nutritional compositions may be formulated to include only the ingredients described herein, or may be modified with optional ingredients to form a number of different product forms. The preterm infant nutritional compositions of the present disclosure are preferably formulated as dietary product forms. Preterm infant formulas are defined herein as those embodiments comprising the ingredients of the present disclosure in a product form that further comprises at least one macronutrient. Non-limiting examples of useful macronutrients include fat, protein, carbohydrate, and combinations thereof. Micronutrients may also be present in the preterm infant nutritional compositions. Non-limiting examples of micronutrients include vitamins, minerals, and combinations thereof.

The preterm infant nutritional compositions of the present disclosure may be formulated as milk-based liquids, soy-based liquids, amino acid-based liquids, low-pH liquids, clear liquids and reconstitutable powders. In certain embodiments, the preterm infant nutritional composition is a liquid preterm infant nutritional composition selected from the group of: liquid infant formula; liquid human milk fortifier; and liquid protein supplement.

### Beta-Hydroxy-Beta Methylbutyric Acid (HMB)

The preterm infant nutritional compositions of the present disclosure comprise HMB, which means that the preterm infant nutritional compositions are either formulated with the addition of HMB, most typically as the monohydrate calcium salt of HMB, or are otherwise prepared so as to contain HMB in the finished product. Any source of HMB is suitable for use herein provided that the finished product contains HMB, although in some embodiments, the source is preferably calcium HMB and is most typically added as such to the preterm infant nutritional compositions during formulation. Other suitable sources may include HMB as the free acid, a salt, an anhydrous salt, an ester, a lactone, or other product forms that otherwise provide a bioavailable form of HMB. Non-limiting examples of suitable salts of HMB for use herein include HMB salts, hydrated or anhydrous, of calcium, sodium, potassium, magnesium, chromium, or other non-toxic salt form and combinations thereof. In certain embodiments, the preterm infant nutritional composition comprises HMB in a form selected from the free acid, a salt, an anhydrous salt, an ester, a lactone, and mixtures thereof. In certain embodiments, the HMB in the preterm infant nutritional composition is a salt of HMB selected from a calcium salt, a sodium salt, a potassium salt, a magnesium salt, a chromium salt, and mixtures thereof. Calcium HMB monohydrate is commercially available from Technical Sourcing International (TSI) of Salt Lake City, Utah and from Lonza Group Ltd. (Basel, Switzerland).

The preterm infant nutritional compositions as described herein may comprise an amount of HMB that is sufficient and effective to promote healthy body composition through accretion of lean body mass, for example, by increasing protein synthesis.

When the preterm infant nutritional composition is a liquid, the concentration of HMB in the liquid may be by weight of the liquid. In some embodiments, the HMB may be present in either a ready-to-feed liquid or a liquid made by reconstituting a powder (i.e., a reconstitutable powder) of the present invention, in an amount greater than about 60 μg, less than about 6,000 mg, less than about 1,500 mg, less than about 300 mg, from about 60 μg to about 6,000 mg, from about 60 μg to about 1,500 mg, or from about 60 μg to about 300 mg per liter of the liquid.

When the preterm infant nutritional composition is a solid such as a powdered composition, the concentration of HMB in the solid may be less than or equal to about 25%, including from about 0.000004% to about 25%, from about 0.0001 to about 25%, from about 0.01 to about 25%, from about 0.1% to about 10%, from about 0.1% to about 5%, from about 0.2% to about 2%, from about 0.3% to about 3%, and also including from about 0.34% to about 1.5%, by weight of the powder. In some embodiments, the HMB is present in a powder preterm infant nutritional composition in an amount of from about 0.01% to about 10% by weight of the powder. In some embodiments, the HMB is present in a powder preterm infant nutritional composition in an amount of from about 0.1% to about 0.5% by weight of the powder.

The concentration of HMB in the liquid preterm infant nutritional composition, including the liquid derived from reconstituting a solid preterm infant nutritional composition, may be measured using the method described in: Baxter, Jeffrey H., “Direct Determination of β-Hydroxy-β-Methylbutyrate (HMB) in Liquid Nutritional Products,” Food Anal. Methods (2001) Vol. 4, 341-346.

### Macronutrients

The preterm infant nutritional compositions of the present disclosure comprise one or more macronutrients in addition to the HMB described herein. The macronutrient may include proteins, fats, carbohydrates, and combinations thereof. The preterm infant nutritional compositions may be formulated as dietary products containing all three macronutrients.

Macronutrients suitable for use herein may include any protein, fat, or carbohydrate or source thereof that is known for or otherwise suitable for use in an oral nutritional composition, provided that the optional macronutrient is safe and effective for oral administration and is otherwise compatible with the other ingredients in the nutritional composition.

The concentration or amount of optional fat, carbohydrate, and protein in the preterm infant nutritional composition may vary considerably depending upon the particular product form (e.g., milk or soy based liquids, amino acid-based liquids, clear liquids, reconstitutable powders) and the various other formulations and targeted dietary needs of the intended user. Such concentrations or amounts of macronutrients most typically fall within one of the embodied ranges described in Table I, wherein each numerical value is to be considered as preceded by the term “about,” inclusive of any other essential fat, protein, and or carbohydrate ingredients as described herein. Note that in relation to powder embodiments, the amounts in the following tables are amounts following reconstitution of the powder.

TABLE I

| Nutrient | | | | |
|---|---|---|---|---|
| (g nutrient/100 | | | | |
| mL of formula) | Example A | Example B | Example C | Example D |
| Protein | 0.7-2.4 | 1.0-3.3 | 5.0-9.0 | 15-20 |
| Fat | 2.0-5.4 | 2.7-7.5 | 4.0-7.0 | 0 |
| Carbohydrate | 5.4-10.8 | 6.1-8.8 | 12.0-20.0 | 0 |

The level or amount of carbohydrate, fat, and protein in the preterm infant nutritional composition (whether a powder formula or a ready-to-feed liquid or concentrated liquid) may also be characterized in addition to or in the alternative as a percentage of total calories in the preterm infant nutritional composition. These macronutrients for preterm infant nutritional compositions of the present disclosure are most typically formulated within any of the caloric ranges described in Table II (each numerical value should be considered to be preceded by the term “about”).

TABLE II

| Nutrient | Example | Example | Example | Example | Example | Example | Example |
|---|---|---|---|---|---|---|---|
| (% total calories) | E | F | G | H | I | J | K |
| Carbohydrate | 2-96 | 10-75 | 30-50 | 25-50 | 25-50 | 25-50 | 0 |
| Fat | 2-96 | 20-85 | 35-60 | 1-20 | 2-20 | 30-60 | 0 |
| Protein | 2-96 | 5-70 | 15-35 | 10-30 | 15-30 | 7.5-25 | 100 |

### Carbohydrate

The preterm infant nutritional compositions of the present disclosure may comprise any carbohydrates that are suitable for use in an oral nutritional product, and which are compatible with the elements and features of such a product.

Carbohydrates suitable for use in the preterm infant nutritional compositions may be simple, complex, or variations or combinations thereof. Non-limiting examples of suitable carbohydrates include hydrolyzed or modified starch or cornstarch, maltodextrin, isomaltulose, sucromalt, glucose polymers, sucrose, corn syrup, corn syrup solids, rice-derived carbohydrate, glucose, fructose, lactose, honey, sugar alcohols (e.g., maltitol, erythritol, sorbitol), and combinations thereof.

Carbohydrates suitable for use herein may include soluble dietary fiber, non-limiting examples of which include gum Arabic, fructooligosaccharide (FOS), galactooligosaccharides (GOS), human milk oligosaccharides, sodium carboxymethyl cellulose, guar gum, citrus pectin, low and high methoxy pectin, oat and barley glucans, carrageenan, psyllium and combinations thereof. Insoluble dietary fiber may also be suitable as a carbohydrate source herein, non-limiting examples of which include oat hull fiber, pea hull fiber, soy hull fiber, soy cotyledon fiber, sugar beet fiber, cellulose, corn bran, and combinations thereof.

### Fat

The preterm infant nutritional compositions of the present disclosure may comprise a source or sources of fat. Suitable sources of fat for use in the preterm infant nutritional compositions disclosed herein include any fat or fat source that is suitable for use in an oral nutritional product and that is compatible with the essential elements and features of such products, provided that such fats are suitable for feeding to preterm infants.

Non-limiting examples of fats suitable for use in the preterm infant nutritional compositions include coconut oil, fractionated coconut oil, soy oil, corn oil, olive oil, safflower oil, high oleic safflower oil, high GLA-safflower oil, medium chain triglycerides (MCT) oil, sunflower oil, high oleic sunflower oil, palm and palm kernel oils, palm olein, canola oil, marine oils, flaxseed oil, borage oil, cottonseed oils, evening primrose oil, blackcurrant seed oil, transgenic oil sources, fungal oils, marine oils (e.g., tuna, sardine), and so forth.

### Protein

The preterm infant nutritional compositions of the present disclosure may comprise protein. Any known or otherwise suitable protein or protein source may be included in the preterm infant nutritional compositions of the present disclosure, provided that such proteins are suitable for feeding to preterm infants, and in particular, newborn preterm infants.

Non-limiting examples of proteins suitable for use in the preterm infant nutritional compositions may include hydrolyzed, partially hydrolyzed or non-hydrolyzed proteins or protein sources, and can be derived from any known or otherwise suitable source such as milk (e.g., casein, whey), animal (e.g., meat, fish, egg albumen), cereal (e.g., rice, corn), vegetable (e.g., soy, pea, potato), or combinations thereof. The proteins for use herein may also include, or be entirely or partially replaced by, free amino acids known for use in nutritional products, non-limiting examples of which include L-leucine, L-tryptophan, L-glutamine, L-tyrosine, L-methionine, L-cysteine, taurine, L-arginine, L-carnitine, and combinations thereof.

In some embodiments, the preterm infant nutritional compositions of the present disclosure may include high amounts of protein as compared to conventional term and preterm infant formulas. For example, the preterm infant nutritional compositions may comprise protein in an amount of from about 15 grams to about 35 grams, from about 18 grams to about 32 grams, or from about 20 grams to about 30 grams of protein per liter of the composition. In some embodiments, the preterm infant nutritional compositions may comprise about 30 grams of protein per liter of the composition.

### Optional Ingredients

The preterm infant nutritional compositions of the present disclosure may further comprise optional components that may modify the physical, chemical, aesthetic or processing characteristics of the compositions or serve as pharmaceutical or additional nutritional components when used in the targeted population. Many such optional ingredients are known or otherwise suitable for use in nutritional compositions or pharmaceutical dosage forms and may also be used in the preterm infant nutritional compositions herein, provided that such optional ingredients are safe and effective for oral administration and are compatible with the other selected ingredients in the composition.

Non-limiting examples of such other optional ingredients include preservatives, anti-oxidants, buffers, additional pharmaceutical actives, sweeteners including artificial sweeteners (e.g., saccharine, aspartame, acesulfame K, sucralose), colorants, flavors, branch chain amino acids, essential amino acids, free amino acids, flavor enhancers, thickening agents and stabilizers, emulsifying agents, lubricants, and so forth.

The preterm infant nutritional compositions of the present disclosure preferably comprise one or more minerals, non-limiting examples of which include phosphorus, sodium, chloride, magnesium, manganese, iron, copper, zinc, iodine calcium, potassium, chromium (e.g., chromium picolinate), molybdenum, selenium, and combinations thereof.

The preterm infant nutritional compositions also desirably comprise one or more vitamins, non-limiting examples of which include carotenoids (e.g., beta-carotene, zeaxanthin, lutein, lycopene), biotin, choline, inositol, folic acid, pantothenic acid, choline, vitamin A, thiamine (vitamin B1), riboflavin (vitamin B2), niacin (vitamin B3), pyridoxine (vitamin B6), cyanocobalamine (vitamin B12), ascorbic acid (vitamin C), vitamin D, vitamin E, vitamin K, and various salts, esters or other derivatives thereof, and combinations thereof. In some preferred embodiments, the preterm infant nutritional compositions of the present disclosure comprise both vitamins and minerals.

The preterm infant nutritional compositions may also desirably comprise probiotics, prebiotics and their related derivatives. The term “probiotic” means a microorganism that exerts beneficial effects on the health of the host. Any suitable probiotic known in the art may be used. For example, the probiotic may be chosen from the group consisting of Lactobacillus and Bifidobacterium. Alternatively, the probiotic can be Lactobacillus rhamnosus GG. The term “prebiotic” as used herein means a non-digestible food ingredient that stimulates the growth and/or activity of probiotics. Any suitable prebiotic known in the art may be used. In a particular embodiment, the prebiotic can be selected from the group consisting of fructooligosaccharide, glucooligosaccharide, galactooligosaccharide, inulin, isomaltooligosaccharide, polydextrose, xylooligosaccharide, lactulose, and combinations thereof.

The preterm infant nutritional compositions of the present disclosure may optionally comprise a flaxseed component, non-limiting examples of which include ground flaxseed and flaxseed oil. Ground flaxseed is generally preferred. Non-limiting examples of flaxseed include red flaxseed, golden flaxseed, and combinations thereof. Golden flaxseed is generally preferred. Commercial sources of flaxseed are well known in the nutrition and formulation arts, some non-limiting examples of which include flaxseed and flax products available from the Flax Council of Canada, the Flax Consortium of Canada, and Heintzman Farms (North Dakota) (Dakota Flax Gold brand).

### Methods of Using the HMB-Containing Nutritional Compositions

The preterm infant nutritional compositions including HMB as described herein can be used in various methods as set forth herein for preterm infants. These methods include, but are not limited to, the oral, parenteral, naso-gastric, gastrostomy or jejunostomy administration of the beta-hydroxy-beta-methylbutyric acid-containing preterm infant nutritional compositions to the individual to promote protein synthesis, to promote growth and accretion of lean body mass, or both in a preterm infant.

The individual desirably consumes at least one serving of the preterm infant nutritional composition daily, and in some embodiments, may consume two, three, or even more servings per day. Each serving is desirably administered as a single, undivided dose, although the serving may also be divided into two or more partial or divided servings to be taken at two or more times during the day. The methods of the present disclosure include continuous day after day administration, as well as periodic or limited administration, although continuous day after day administration is generally desirable. The methods of the present disclosure are preferably applied on a daily basis, wherein the daily administration is maintained continuously for at least 3 days, including at least 5 days, including at least 1 week, including at least 2 weeks, including at least 1 month, including at least 6 weeks, including at least 8 weeks, including at least 2 months, including at least 6 months, desirably for at least 18-24 months, and desirably as a long term, continuous, daily, dietary supplement.

In certain embodiments, the preterm infant nutritional composition is formulated as a liquid human milk fortifier. The liquid human milk fortifiers of the present disclosure comprise HMB at from about 60 μg to about 6,000 mg per liter of the composition, and have an energy density of from about 2 kcal to about 10 kcal per 5 ml of the fortifier. In certain embodiments, the liquid human milk fortifier has an energy density of from about 3 kcal to about 8 kcal per 5 ml of the fortifier. In other embodiments, the liquid human milk fortifier has an energy density of about 6.85 kcal per 5 ml of the fortifier. The liquid human milk fortifier of the present disclosure may be used in combination with human milk or other suitable infant formula, wherein the resulting fortified human milk or fortified infant formula has an osmolality suitable for oral administration to an infant, and particularly to a preterm infant. The osmolality may typically be less than about 500 mOsm/kg water, from about 300 mOsm/kg water to about 400 mOsm/kg water.

The liquid human milk fortifier of the present disclosure may be added directly to human milk in a volume to volume ratio of from about 1:3 to about 1:9, including from about 1:3.5 to about 1:7, and also including from about 1:4 to about 1:6. The ratio is ultimately selected based primarily upon the ingredients and osmolality of the concentrated liquid human milk fortifier and in view of the particular nutritional needs of the preterm infant. The liquid human milk fortifier may be added directly to every feeding or to a sufficient number of feedings (e.g., once or twice daily) to provide optimal nutrition in view of the particular nutritional needs of the preterm infant.

Human milk or other infant formula, after fortification with the concentrated liquid human milk fortifier will may have a caloric density ranging from about 19 kcal/fl oz (0.64 kcal/ml) to about 26.7 kcal/fl oz (0.9 kcal/ml), with the 22-25 kcal/fl oz formulations (0.74-0.84 kcal/ml) being more useful in preterm infants, and the 19-21 kcal/fl oz (0.64-0.71 kcal/ml) formulations more useful for term infants.

In certain embodiments, the preterm infant nutritional composition is formulated as a powdered human milk fortifier. The powdered human milk fortifiers of the present disclosure comprise HMB at less than about 200 g, less than about 50 g, less than about 10 g, or less than about 2 mg of HMB per kilogram of the fortifier. In some embodiments, the powdered human milk fortifiers comprise from about 2 mg to about 200 g of HMB per kilogram of the fortifier, or from about 10 g to about 50 g of HMB per kilogram of the fortifier. The powdered human milk fortifier may have an energy density of from about 200 to about 600 kcal, or from about 300 to about 500 kcal, per kilogram of the fortifier. In some embodiments, the powdered human milk fortifier may have an energy density of about 389 kcal/100 g. The powdered human milk fortifier can be administered in any suitable way, for example, as added to human milk and delivered orally or via naso-gastric and other modes of tube feeding.

In certain embodiments, the preterm infant nutritional composition is formulated as a liquid protein supplement. The liquid protein supplements of the present disclosure comprise HMB at from about 60 μg to about 6,000 mg per liter of the supplement, and have an energy density of from about 2 to about 10 kcal, or from about 4 to about 6 kcal, per 6 ml of the supplement. In some embodiments, the liquid protein supplement composition has an energy density of about 4 kcal per 6 ml of the supplement. The liquid protein supplement of the present disclosure may be used in combination with human milk or other suitable infant formula, wherein the resulting supplemented human milk or supplemented infant formula has an osmolality suitable for oral administration to an infant, and particularly to a preterm infant. The osmolality may typically be less than about 500 mOsm/kg water, from about 300 mOsm/kg water to about 400 mOsm/kg water.

The liquid protein supplement of the present disclosure may be added directly to human milk in a volume to volume ratio of from about 1:10 to about 1:20, including from about 1:12 to about 1:18, and also including from about 1:14 to about 1:16. The ratio is ultimately selected based primarily upon the ingredients and osmolality of the concentrated liquid protein supplement and in view of the particular nutritional needs of the preterm infant. The liquid protein supplement may be added directly to every feeding or to a sufficient number of feedings (e.g., once or twice daily) to provide optimal nutrition in view of the particular nutritional needs of the preterm infant.

Human milk or other infant formula, after supplementation with the concentrated liquid protein supplement will may have a caloric density ranging from about 19 kcal/fl oz (0.64 kcal/ml) to about 26.7 kcal/fl oz (0.9 kcal/ml), with the 22-25 kcal/fl oz formulations (0.74-0.84 kcal/ml) being more useful in preterm infants, and the 19-21 kcal/fl oz (0.64-0.71 kcal/ml) formulations more useful for term infants.

The methods of the present disclosure as described herein are also intended to include the use of such methods in individuals that may not have a high demand for protein synthesis for growth.

Method of Manufacture

The preterm infant nutritional compositions of the present disclosure may be prepared by any known or otherwise effective manufacturing technique for preparing the selected product form. Many such techniques are known for any given product form such as nutritional liquids or nutritional powders, and can easily be applied by one of ordinary skill in the nutrition and formulation arts to the preterm infant nutritional compositions described herein.

Liquid, milk or soy-based nutritional liquids, for example, may be prepared by first forming an oil and fiber blend containing all formulation oils, any emulsifier, fiber and fat-soluble vitamins. Additional slurries (typically a carbohydrate and two protein slurries) are prepared separately by mixing the HMB, carbohydrate and minerals together and the protein in water. The slurries are then mixed together with the oil blend. The resulting mixture is homogenized, heat processed, standardized with any water-soluble vitamins, flavored and the liquid terminally sterilized or aseptically filled or dried, such as by spray drying, to produce a powder.

The solid nutritional embodiments of the present disclosure may also be manufactured through a baked application or heated extrusion to produce solid product forms such as cereals, cookies, crackers, and similar other product forms. One knowledgeable in the nutrition manufacturing arts is able to select one of the many known or otherwise available manufacturing processes to produce the desired final product.

In embodiments in which the preterm infant nutritional composition is a liquid human milk fortifier, the following method may be utilized. The concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) as well as HMB are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MN) slurry is prepared by heating appropriate amount of water to 140-160° F. With agitation, the following soluble ingredients are added: a carbohydrate source, HMB, and minerals such as potassium citrate, magnesium chloride, potassium chloride, sodium chloride, and choline chloride. The carbohydrate-mineral slurry is held at 130-150° F. under agitation until added to the blend.

An intermediate oil slurry is prepared by heating oil blend such as MCT oil and coconut oil to 150-170° F. and then adding an emulsifier such as distilled monoglycerides with agitation for minimum 10 minutes in order to the ingredient to dissolve. Soy oil, oil soluble vitamins such as vitamin A palmitate, vitamin D3, dl-alpha-tocopheryl-acetate, phylloquinone, ARA, DHA, and carotenoids then added with agitation to the oil blend. A mineral calcium source, such as ultra-micronized tricalcium phosphate, is added to the oil. Additionally if needed stabilizers such as gellan gum and OSA-modified starch are then added to the oil blend with proper agitation. The oil blend slurry is maintained at 130-150° F. under agitation until added to the blend.

The blend is prepared by combining the ingredient water, a protein source, all of the CHO-MN slurry including HMB and whole oil blend slurry. The blend is maintained at 120° F. for a period of time not to exceed two hours before further processing.

The blend is then homogenized using one or more in-line homogenizers at pressures from 1000-4000 psig with or without a second stage homogenization from 100-1100 psig followed by heat treatment using a UHTST (ultra-high temperature short time, 292-297° F. for 5-15 seconds) process. After the appropriate heat treatment, the batch is cooled in a plate cooler to 33-45° F. and then transferred to a refrigerated holding tank, where it is subjected to analytical testing.

The next step in the manufacturing process involves adding vitamins, trace minerals and water in order to reach the final target total solids and vitamin/mineral contents. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution prepared by heating water to 80-100° F. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, cyanocobalamin, folic acid, calcium pantothenate, niacinamide, biotin, m-inositol, nucleotide/choline premix, L-carnitine, L-Leucine, and L-tyrosine.

A vitamin C solution is prepared by adding ascorbic acid to water solution with agitation.

All standardization solutions are then added to the refrigerated batch, with agitation. The appropriate amount of ingredient dilution water is then added to the batch to achieve a target total solids level. The final batch is then subjected to appropriate thermal treatment and filled into a suitable container under an aseptic conditions and processes.

The preterm infant nutritional compositions of the present disclosure may, of course, be manufactured by other known or otherwise suitable techniques not specifically described or shown herein without departing from the spirit and scope of the present disclosure. The present embodiments are, therefore, to be considered in all respects as illustrative and not restrictive and that all changes and equivalents also come within the description of the present disclosure. The following non-limiting examples will further illustrate the compositions and methods of the present disclosure.

### Examples

The following Examples provide data and/or illustrate specific embodiments and/or features of the preterm infant nutritional compositions and methods of the present disclosure. The Examples are given solely for the purpose of illustration and are not to be construed as limitations, as many variations thereof are possible without departing from the spirit and scope of the disclosure.

The following tables describe eleven exemplary compositions according to the present disclosure, wherein the compositions have differing caloric densities.

Example 1, which is found in Table III, is a ready-to-feed liquid preterm infant formula that is useful for feeding a newborn preterm infant through hospital discharge or longer as needed. The liquid preterm infant formula has a caloric density of 676 kcal/L (20 kcal/mL) and contains 2 mg HMB per liter of formula.

TABLE III

| | | Amount per | | |
|---|---|---|---|---|
| Ingredient Name | | 1000 Kg | | Units |
| Ingredient Water | | Q.S. | | Kg |
| Nonfat Milk | | 97.50 | | Kg |
| Corn Syrup | | 33.71 | | Kg |
| Medium Chain Triglycerides | | 17.30 | | Kg |
| Lactose | | 16.28 | | Kg |
| Whey Protein Concentrate | | 12.69 | | Kg |
| Soy Oil | | 10.40 | | Kg |
| Coconut Oil | | 6.30 | | Kg |
| 5% KOH | | 4.86 | | Kg |
| | Potassium Hydroxide | | 243 | g |
| Ultra-Micronized Tricalcium Phosphate | | 2.56 | | Kg |
| Ascorbic Acid | | 870 | | g |
| Vitamin/Mineral/Taurine Premix | | 538 | | g |
| | m-Inositol | | 313.7 | g |
| | Zinc Sulfate | | 48.31 | g |
| | Taurine | | 43.49 | g |
| | Niacinamide | | 38.23 | g |
| | Calcium Pantothenate | | 18.80 | g |
| | Ferrous Sulfate | | 14.57 | g |
| | Cupric Sulfate | | 8.79 | g |
| | Riboflavin | | 4.94 | g |
| | Thiamine Chloride Hydrochloride | | 3.27 | g |
| | Pyridoxine Hydrochloride | | 2.98 | g |
| | Folic Acid | | 716.8 | mg |
| | Biotin | | 335.4 | mg |
| | Manganese Sulfate | | 92.0 | mg |
| | Sodium Selenate | | 22.58 | mg |
| | Cyanocobalamin | | 12.96 | mg |
| Magnesium Chloride | | 405 | | g |
| Soy Lecithin | | 364 | | g |
| Monoglycerides | | 364 | | g |
| AA Fungal Oil | | 364 | | g |
| Potassium Citrate | | 341 | | g |
| Carrageenan | | 300 | | g |
| Nucleotide-Choline Premix | | 293 | | g |
| | Choline Bitartrate | | 23.50 | g |
| | Cytidine 5′-Monophosphate | | 13.83 | g |
| | Disodium Guanosine 5′-Monophosphate | | 7.10 | g |
| | Disodium Uridine 5′-Monophosphate | | 5.97 | g |
| | Adenosine 5′-Monophosphate | | 5.26 | g |
| Sodium Citrate | | 250 | | g |
| DHA Algal Oil | | 229 | | g |
| Potassium Chloride | | 138 | | g |
| Calcium Carbonate | | 101 | | g |
| Vitamin ADEK premix | | 82.60 | | g |
| | RRR Alpha-Tocopheryl Acetate | | 25.43 | g |
| | Vitamin A Palmitate | | 6.49 | g |
| | Vitamin K1 (Phylloquinone) | | 111.0 | mg |
| | Vitamin D3 | | 30.8 | mg |

| | | |
|---|---|---|
| Ferrous Sulfate | 48.93 | g |
| Choline Chloride | 35.00 | g |
| L-Carnitine | 30.70 | g |
| Calcium HMB | 2.5 | g |
| Lutein | 175 | mg |
| Vitamin A | 772 | mg |
| Beta-Carotene | 121 | mg |
| Sodium Chloride | as needed | |
| Potassium Phosphate | as needed | |

Example 2, which is found in Table IV, is a ready-to-feed liquid preterm infant formula that is useful for feeding a newborn preterm infant through hospital discharge or longer as needed. The liquid preterm infant formula has a caloric density of 812 kcal/L (24 kcal/mL) and contains 2 mg HMB per liter of formula.

TABLE IV

| | | Amount per | | |
|---|---|---|---|---|
| Ingredient Name | | 1000 Kg | | Units |
| Ingredient Water | | Q.S. | | Kg |
| Nonfat Milk | | 115.8 | | Kg |
| Corn Syrup | | 40.6 | | Kg |
| Medium Chain Triglycerides | | 20.5 | | Kg |
| Lactose | | 20.0 | | Kg |
| Whey Protein Concentrate | | 15.1 | | Kg |
| Soy Oil | | 12.3 | | Kg |
| Coconut Oil | | 7.5 | | Kg |
| 5% KOH | | 5.1 | | Kg |
| | Potassium Hydroxide | | 255 | g |
| Ultra-Micronized Tricalcium Phosphate | | 2.58 | | Kg |
| Ascorbic Acid | | 913 | | g |
| Vitamin/Mineral/Taurine Premix | | 642.2 | | g |
| | m-Inositol | | 375.0 | g |
| | Zinc Sulfate | | 57.75 | g |
| | Taurine | | 52.00 | g |
| | Niacinamide | | 45.69 | g |
| | Calcium Pantothenate | | 22.43 | g |
| | Ferrous Sulfate | | 17.42 | g |
| | Cupric Sulfate | | 10.50 | g |
| | Riboflavin | | 5.91 | g |
| | Thiamine Chloride Hydrochloride | | 3.91 | g |
| | Pyridoxine Hydrochloride | | 3.56 | g |
| | Folic Acid | | 857 | mg |
| | Biotin | | 401 | mg |
| | Manganese Sulfate | | 110 | mg |
| | Sodium Selenate | | 27.0 | mg |
| | Cyanocobalamin | | 15.5 | mg |
| Soy Lecithin | | 433.0 | | g |
| Monoglycerides | | 433.0 | | g |
| AA Fungal Oil | | 432.0 | | g |
| Magnesium Chloride | | 431.0 | | g |
| Sodium Citrate | | 328.0 | | g |
| Calcium Carbonate | | 318.0 | | g |
| Carrageenan | | 300.0 | | g |
| Nucleotide-Choline Premix | | 293 | | g |
| | Choline Bitartrate | | 23.50 | g |
| | Cytidine 5′-Monophosphate | | 13.83 | g |
| | Disodium Guanosine 5′-Monophosphate | | 7.10 | g |
| | Disodium Uridine 5′-Monophosphate | | 5.97 | g |
| | Adenosine 5′-Monophosphate | | 5.26 | g |
| Potassium Citrate | | 288.7 | | g |
| DHA Algal Oil | | 271.0 | | g |
| Potassium Chloride | | 233.0 | | g |
| Vitamin ADEK premix | | 98.9 | | g |
| | RRR Alpha-Tocopheryl Acetate | | 30.56 | g |
| | Vitamin A Palmitate | | 7.8 | g |
| | Vitamin K1 (Phylloquinone) | | 133 | mg |
| | Vitamin D3 | | 37 | mg |

| | | |
|---|---|---|
| Ferrous Sulfate | 58.30 | g |
| Choline Chloride | 48.10 | g |
| L-Carnitine | 36.60 | g |
| Calcium HMB | 2.5 | g |
| Lutein | 173 | mg |
| Vitamin A | 111 | mg |
| Beta-Carotene | 401 | mg |
| Sodium Chloride | as needed | |
| Potassium Phosphate | as needed | |

Example 3, which is found in Table V, is a ready-to-feed liquid preterm infant formula that is useful for feeding a newborn preterm infant through hospital discharge or longer as needed. The liquid preterm infant formula has a caloric density of 812 kcal/L (24 kcal/mL) and contains 2 mg HMB per liter of formula.

TABLE V

| | | Amount per | | |
|---|---|---|---|---|
| Ingredient Name | | 1000 Kg | | Units |
| Ingredient Water | | Q.S. | | Kg |
| Nonfat Milk | | 127.3 | | Kg |
| Corn Syrup | | 39.0 | | Kg |
| Medium Chain Triglycerides | | 20.7 | | Kg |
| Whey Protein Concentrate | | 16.6 | | Kg |
| Lactose | | 16.1 | | Kg |
| Soy Oil | | 12.4 | | Kg |
| Coconut Oil | | 7.56 | | Kg |
| 5% KOH | | 5.10 | | Kg |
| | Potassium Hydroxide Solids | | 0.2550 | g |
| Ultra-Micronized Tricalcium Phosphate | | 2.41 | | Kg |
| Ascorbic Acid | | 913 | | g |
| Vitamin/Mineral/Taurine Premix | | 642 | | g |
| | m-Inositol | | 375 | g |
| | Zinc Sulfate | | 57.75 | g |
| | Taurine | | 52.00 | g |
| | Niacinamide | | 45.70 | g |
| | Calcium Pantothenate | | 22.47 | g |
| | Ferrous Sulfate | | 17.42 | g |
| | Cupric Sulfate | | 10.50 | g |
| | Riboflavin | | 5.91 | g |
| | Thiamine Chloride Hydrochloride | | 3.91 | g |
| | Pyridoxine Hydrochloride | | 3.56 | g |
| | Folic Acid | | 857 | mg |
| | Biotin | | 401 | mg |
| | Manganese Sulfate | | 110 | mg |
| | Sodium Selenate | | 27.0 | mg |
| | Cyanocobalamin | | 15.5 | mg |
| Calcium Carbonate | | 476 | | g |
| Soy Lecithin | | 433 | | g |
| Monoglycerides | | 433 | | g |
| AA Fungal Oil | | 432 | | g |
| Magnesium Chloride | | 424 | | g |
| Nucleotide-Choline Premix | | 293 | | g |
| | Choline Bitartrate | | 23.50 | g |
| | Cytidine 5′-Monophosphate | | 13.83 | g |
| | Disodium Guanosine 5′-Monophosphate | | 7.10 | g |
| | Disodium Uridine 5′-Monophosphate | | 5.97 | g |
| | Adenosine 5′-Monophosphate | | 5.26 | g |
| DHA Algal Oil | | 271 | | g |
| Potassium Citrate | | 261 | | g |
| Sodium Citrate | | 203 | | g |
| Potassium Chloride | | 196 | | g |
| Carrageenan | | 150 | | g |
| Carrageenan | | 150 | | g |
| Vitamin ADEK Premix | | 98.9 | | g |
| | RRR Alpha-Tocopheryl Acetate | | 30.56 | g |
| | Vitamin A Palmitate | | 7.81 | g |
| | Vitamin K1 (Phylloquinone) | | 133.00 | mg |
| | Vitamin D3 | | 37.00 | mg |

| | | |
|---|---|---|
| Ferrous Sulfate | 58.4 | g |
| Choline Chloride | 48.1 | g |
| L-Carnitine | 36.6 | g |
| Calcium HMB | 2.5 | g |
| Lutein | 174 | mg |
| Vitamin A | 485 | mg |
| Beta-Carotene | 401 | mg |
| Sodium Chloride | as needed | |
| Potassium Phosphate | as needed | |

Example 4, which is found in Table VI, is a ready-to-feed liquid preterm infant formula that is useful for feeding a newborn preterm infant through hospital discharge or longer as needed. The liquid preterm infant formula has a caloric density of 1014 kcal/L (30 kcal/mL) and contains 2 mg HMB per liter of formula.

TABLE VI

| | | Amount Per | | |
|---|---|---|---|---|
| Ingredient Name | | 1000 Kg | | Units |
| Ingredient Water | | Q.S. | | Kg |
| Nonfat Milk | | 180.7 | | Kg |
| Corn Syrup | | 38.67 | | Kg |
| Medium Chain Triglycerides | | 31.70 | | Kg |
| Soy Oil | | 19.00 | | Kg |
| Whey Protein Concentrate | | 14.11 | | Kg |
| Coconut Oil | | 11.56 | | Kg |
| Lactose | | 6.85 | | Kg |
| 5% KOH | | 6.37 | | Kg |
| | Potassium Hydroxide | | 0.3187 | g |
| Ultra-Micronized Tricalcium Phosphate | | 2.81 | | Kg |
| Ascorbic Acid | | 1.14 | | Kg |
| Vitamin/Mineral/Taurine Premix | | 802.7 | | g |
| | m-Inositol | | 469.04 | g |
| | Zinc Sulfate | | 72.24 | g |
| | Taurine | | 65.04 | g |
| | Niacinamide | | 57.16 | g |
| | Calcium Pantothenate | | 28.11 | g |
| | Ferrous Sulfate | | 21.79 | g |
| | Cupric Sulfate | | 13.14 | g |
| | Riboflavin | | 7.39 | g |
| | Thiamine Chloride HCl | | 4.88 | g |
| | Pyridoxine HCl | | 4.45 | g |
| | Folic Acid | | 1.072 | g |
| | Biotin | | 501.6 | mg |
| | Manganese Sulfate | | 137.6 | mg |
| | Sodium Selenate | | 33.77 | mg |
| | Cyanocobalamin | | 19.39 | mg |
| Calcium Carbonate | | 680 | | g |
| Soy Lecithin | | 659 | | g |
| Monoglycerides | | 659 | | g |
| Magnesium Chloride | | 554 | | g |
| AA Fungal Oil | | 541 | | g |
| Sodium Citrate | | 438.5 | | g |
| Nucleotide-Choline Premix | | 366.5 | | g |
| | Choline Bitartrate | | 29.40 | g |
| | Cytidine 5′-Monophosphate | | 17.30 | g |
| | Disodium Guanosine 5′-Monophosphate | | 8.88 | g |
| | Disodium Uridine 5′-Monophosphate | | 7.47 | g |
| | Adenosine 5′-Monophosphate | | 6.58 | g |
| DHA Algal Oil | | 339.0 | | g |
| Vitamin A, D3, E, K1 Premix | | 123.60 | | g |
| | RRR Alpha-Tocopheryl Acetate | | 38.15 | g |
| | Vitamin A Palmitate | | 9.75 | g |
| | Vitamin K1 (Phylloquinone) | | 166 | mg |
| | Vitamin D3 | | 46 | mg |

| | | |
|---|---|---|
| Carrageenan | 120.0 | g |
| Ferrous Sulfate | 72.97 | g |
| Choline Chloride | 60.07 | g |
| L-Carnitine | 40.34 | g |
| Potassium Citrate (2) | 4.60 | g |
| Thiamine HCL | 4.34 | g |
| Calcium HMB | 2.5 | g |
| Riboflavin | 1.76 | g |
| Lutein | 173 | mg |
| Beta-Carotene | 401 | mg |
| Potassium Citrate (1) | as needed | |
| Potassium Chloride | as needed | |
| Potassium Phosphate | as needed | |

Example 5, which is found in Table VII, is a ready-to-feed, nutrient-enriched liquid preterm infant formula that is useful for feeding a newborn preterm infant after hospital discharge and through the first year of life. The liquid preterm infant formula has a caloric density of 744 kcal/L (22 kcal/mL) and contains 2 mg HMB per liter of formula.

TABLE VII

| | | Amount per | | |
|---|---|---|---|---|
| Ingredient Name | | 1000 Kg | | Units |
| Ingredient Water | | Q.S. | | Kg |
| Condensed Skim Milk | | 120.71 | | Kg |
| Corn Syrup Solids | | 35.35 | | Kg |
| Soybean Oil | | 17.20 | | Kg |
| Lactose | | 14.96 | | Kg |
| Coconut Oil | | 11.16 | | Kg |
| Whey Protein Concentrate | | 10.04 | | Kg |
| Medium Chain Triglyceride Oil | | 9.59 | | Kg |
| Potassium Hydroxide | | 4.32 | | Kg |
| Ascorbic Acid | | 696.0 | | g |
| Potassium Citrate | | 495.5 | | g |
| Calcium Carbonate | | 465.0 | | g |
| Lecithin | | 403.0 | | g |
| Soy monoglycerides | | 403.0 | | g |
| ARASCO ARA Oil | | 392.7 | | g |
| Ultramicronized Tricalcium Phosphate | | 376.0 | | g |
| Nucleotide/Choline Premix | | 293.2 | | g |
| | Choline Bitartrate | | 51.66 | g |
| | Cytidine 5′-Monophosphate | | 30.40 | g |
| | Disodium Guanosine 5′-Monophosphate | | 15.65 | g |
| | Disodium Uridine 5′-Monophosphate | | 13.15 | g |
| | Adenosine 5′-Monophosphate | | 11.59 | g |
| Vitamin/Mineral/Taurine Premix | | 254.1 | | g |
| | Taurine | | 77.58 | g |
| | m-Inositol | | 56.38 | g |
| | Zinc Sulfate | | 26.05 | g |
| | Niacinamide | | 15.65 | g |
| | Calcium Pantothenate | | 10.03 | g |
| | Ferrous Sulfate | | 8.92 | g |
| | Cupric Sulfate | | 3.11 | g |
| | Thiamine Chloride HCl | | 2.57 | g |
| | Riboflavin | | 1.13 | g |
| | Pyridoxine HCl | | 1.07 | g |
| | Folic Acid | | 348.0 | mg |
| | Manganese Sulfate | | 293.0 | mg |
| | Biotin | | 100.0 | mg |
| | Sodium Selenate | | 59.7 | mg |
| | Cyanocobalamin | | 8.0 | mg |
| DHASCO DHA Oil | | 243.4 | | g |
| Magnesium Chloride | | 233.0 | | g |
| m-Inositol | | 208.6 | | g |
| Carrageenan | | 80.0 | | g |
| Choline Chloride | | 74.0 | | g |
| Vitamin ADEK Premix | | 64.5 | | g |
| | d-Alpha-Tocopheryl Acetate | | 32.2 | g |
| | Vitamin A Palmitate | | 2.4 | g |
| | Phylloquinone | | 31.8 | mg |
| | Vitamin D₃ | | 17.1 | mg |

| | | |
|---|---|---|
| Potassium Chloride | 63.0 | g |
| Ferrous Sulfate | 53.2 | g |
| L-Carnitine | 44.5 | g |
| Calcium HMB | 2.5 | g |
| Lutein | 138 | mg |
| Riboflavin | 626.1 | mg |
| Vitamin A Palmitate | 573.2 | mg |
| Beta-Carotene | 58.0 | mg |
| Sodium Chloride | as needed | |
| Potassium Phosphate | as needed | |

Example 6, which is found in Table VIII, is a ready-to-feed, nutrient-enriched liquid preterm infant formula that is useful for feeding a newborn preterm infant after hospital discharge and through the first year of life. The liquid preterm infant formula has a caloric density of 744 kcal/L (22 kcal/mL) and contains 2 mg HMB per liter of formula.

TABLE VIII

| | | Amount per | | |
|---|---|---|---|---|
| Ingredient Name | | 1000 Kg | | Units |
| Ingredient Water | | Q.S. | | Kg |
| Condensed Skim Milk | | 120.7 | | Kg |
| Corn Syrup Solids | | 35.54 | | Kg |
| Lactose | | 15.38 | | Kg |
| Soybean Oil | | 10.83 | | Kg |
| High Oleic Safflower Oil | | 10.44 | | Kg |
| Whey Protein Concentrate | | 10.04 | | Kg |
| Medium Chain Triglyceride Oil | | 9.67 | | Kg |
| Coconut Oil | | 7.19 | | Kg |
| Potassium Hydroxide | | 2.19 | | Kg |
| Potassium Citrate | | 706.8 | | g |
| ARASCO ARA Oil | | 411.1 | | g |
| Lecithin | | 403.0 | | g |
| Monoglycerides | | 403.0 | | g |
| Calcium Carbonate | | 398.6 | | g |
| Ascorbic Acid | | 392.4 | | g |
| Ultramicronized Tricalcium Phosphate | | 375.7 | | g |
| Nucleotide/Choline Premix | | 293.2 | | g |
| | Choline Bitartrate | | 51.66 | g |
| | Cytidine 5′-Monophosphate | | 30.40 | g |
| | Disodium Guanosine 5′-Monophosphate | | 15.65 | g |
| | Disodium Uridine 5′-Monophosphate | | 13.15 | g |
| | Adenosine 5′-Monophosphate | | 11.59 | g |
| Vitamin/Mineral/Taurine Premix | | 254.1 | | g |
| | Taurine | | 77.58 | g |
| | m-Inositol | | 56.38 | g |
| | Zinc Sulfate | | 26.05 | g |
| | Niacinamide | | 15.65 | g |
| | Calcium Pantothenate | | 10.03 | g |
| | Ferrous Sulfate | | 8.92 | g |
| | Cupric Sulfate | | 3.11 | g |
| | Thiamine Chloride HCl | | 2.57 | g |
| | Riboflavin | | 1.13 | g |
| | Pyridoxine HCl | | 1.07 | g |
| | Folic Acid | | 348.0 | mg |
| | Manganese Sulfate | | 293.0 | mg |
| | Biotin | | 100.0 | mg |
| | Sodium Selenate | | 59.7 | mg |
| | Cyanocobalamin | | 8.0 | mg |
| DHASCO DHA Oil | | 245.3 | | g |
| Magnesium Chloride | | 232.8 | | g |
| m-Inositol | | 208.6 | | g |
| Carrageenan | | 200.0 | | g |
| Carrageenan | | 100.0 | | g |
| Choline Chloride | | 76.5 | | g |
| Potassium Chloride | | 61.9 | | g |
| Vitamin ADEK Premix | | 61.4 | | g |
| | d-Alpha-Tocopheryl Acetate | | 30.7 | g |
| | Vitamin A Palmitate | | 2.3 | g |
| | Phylloquinone | | 30.3 | mg |
| | Vitamin D₃ | | 16.3 | mg |

| | | |
|---|---|---|
| Ferrous Sulfate | 53.2 | g |
| L-Carnitine | 44.5 | g |
| Calcium HMB | 2.5 | g |
| Riboflavin | 800.0 | mg |
| Lutein | 138 | mg |
| Vitamin A Palmitate | 500.0 | mg |
| Beta-Carotene | 57.9 | mg |
| Sodium Chloride | as needed | |
| Potassium Phosphate | as needed | |

Example 7, which is found in Table IX, is a nutrient-enriched powdered preterm infant formula that is useful for feeding a newborn preterm infant after hospital discharge and through the first year of life. The powdered preterm infant formula, after reconstitution, has a caloric density of 744 kcal/L (22 kcal/mL) and contains 2 mg HMB per liter of formula. The reconstitution rate is 144.2 grams powder per liter.

TABLE IX

| | | Amount per | | |
|---|---|---|---|---|
| Ingredient Name | | 1000 Kg | | Units |
| Condensed Skim Milk | | 866.7 | | Kg |
| Corn syrup solids | | 260.8 | | Kg |
| Lactose | | 106.1 | | Kg |
| Soybean Oil | | 78.65 | | Kg |
| High Oleic Safflower Oil | | 75.84 | | Kg |
| Whey Protein Concentrate | | 72.10 | | Kg |
| Medium Chain Triglyceride Oil | | 70.22 | | Kg |
| Coconut Oil | | 52.24 | | Kg |
| Potassium Citrate | | 4.98 | | Kg |
| Micronized Tricalcium Phosphate | | 4.32 | | Kg |
| Ascorbic Acid | | 3.44 | | Kg |
| ARASCO ARA Oil | | 2.90 | | Kg |
| Nucleotide-Choline Premix | | 2.35 | | Kg |
| | Choline Bitartrate | | 414.1 | g |
| | Cytidine 5′-Monophosphate | | 243.8 | g |
| | Disodium Guanosine 5′-Monophosphate | | 125.4 | g |
| | Disodium Uridine 5′-Monophosphate | | 105.4 | g |
| | Adenosine 5′-Monophosphate | | 92.9 | g |
| Calcium Carbonate | | 2.26 | | Kg |
| Water-Soluble Vitamin Premix | | 1.82 | | Kg |
| | Taurine | | 555.5 | g |
| | m-Inositol | | 403.9 | g |
| | Zinc Sulfate | | 186.5 | g |
| | Niacinamide | | 118.6 | g |
| | Calcium Pantothenate | | 71.9 | g |
| | Ferrous Sulfate | | 63.9 | g |
| | Cupric Sulfate | | 22.3 | g |
| | Thiamine Chloride HCl | | 18.4 | g |
| | Riboflavin | | 8.1 | g |
| | Pyridoxine HCl | | 7.5 | g |
| | Folic Acid | | 2.5 | g |
| | Manganese Sulfate | | 2.1 | g |
| | Biotin | | 718.7 | mg |
| | Sodium Selenate | | 426.7 | mg |
| | Cyanocobalamin | | 57.31 | mg |
| DHASCO DHA Oil | | 1.81 | | Kg |
| m-Inositol | | 1.62 | | Kg |
| Magnesium Chloride | | 1.60 | | Kg |
| Powdered Soy Lecithin | | 1.11 | | Kg |
| Potassium Chloride | | 854.8 | | g |
| Vitamin ADEK Premix | | 407.8 | | g |
| | d-Alpha-Tocopheryl Acetate | | 203.7 | g |
| | Vitamin A Palmitate | | 15.5 | g |
| | Phylloquinone | | 897.2 | mg |
| | Vitamin D₃ | | 108.6 | mg |

| | | |
|---|---|---|
| Choline Chloride | 403.2 | g |
| Ferrous Sulfate | 380.3 | g |
| Ascorbyl Palmitate | 346.8 | g |
| L-Carnitine | 299.8 | g |
| Mixed Tocopherols | 165.3 | g |
| Calcium HMB | 17.6 | g |
| Vitamin A Palmitate | 6.22 | g |
| Lutein | 0.986 | g |
| Beta-Carotene | 0.414 | g |
| Sodium Citrate | 0-2.0 | Kg |
| Sodium Chloride | 0-2.0 | Kg |
| Potassium Phosphate Dibasic | 0-2.0 | Kg |
| Potassium Hydroxide (processing aid) | as needed | |

Example 8, which is found in Table X, is a powdered human milk fortifier that is useful as a nutritional supplement to add to human milk that is fed to preterm infants starting when tolerance to enteral feeds is established and continued until infants reach a weight of 3600 grams or larger as needed. The powdered human milk fortifier has a caloric density of 3.5 kcal/0.9 grams powder. When one 0.9 gram packet of powdered human milk fortifier is added to 100 ml of human milk it contains 2 mg HMB per liter of fortified human milk.

TABLE X

| | Amount per | |
|---|---|---|
| Ingredient Name | 18000 lbs | Units |
| Ingredient Water | Q.S. | |
| Nonfat Milk Solids | 7220 | lb |
| Corn Syrup Solids | 2870 | lb |
| Medium Chain Triglycerides | 1760 | lb |
| Whey Protein Concentrate | 3410 | lb |
| Tricalcium Phosphate | 701 | kg |
| Potassium Citrate Tribasic, monohydrate | 224 | kg |
| Ascorbic Acid | 136 | kg |
| Magnesium Chloride, hexahydrate | 117 | kg |
| Sodium Chloride | 4.71 | kg |
| m-Inositol | 11.0 | kg |
| Sodium Citrate, Tribasic, dihydrate | 23.9 | kg |
| Ferrous Sulfate | 4.0 | kg |
| Soy Lecithin | 16.8 | kg |
| Zinc Sulfate, heptahydrate | 11.1 | kg |
| Vitamin E Acetate | 7.6 | kg |
| Vitamin A Palmitate | 2.4 | kg |
| Niacinamide | 9.8 | kg |
| Riboflavin | 1.1 | kg |
| Calcium Pantothenate | 4.4 | kg |
| Cupric Sulfate, pentahydrate | 1.8 | kg |
| Thiamine Hydrochloride | 737 | g |
| Pyridoxine Hydrochloride | 655 | g |
| Calcium HMB | 545 | g |
| Vitamin D3 | 410 | g |
| Biotin | 82 | g |
| Folic Acid | 77 | g |
| Cyanocobalamin | 2.0 | g |
| Phylloquinone | 27 | g |
| Manganese Sulfate, monohydrate | 51 | g |
| Sodium Selenate | 1.1 | g |
| Calcium Carbonate, anhydrous | As needed | |
| Potassium Phosphate Monobasic, anhydrous | As needed | |
| Potassium Hydroxide | 24 | kg |

Example 9, which is found in Table XI, is a concentrated liquid human milk fortifier that is useful as a nutritional supplement to add to human milk that is fed to preterm infants. The liquid human milk fortifier has a caloric density of 6.85 kcal/5 ml packet. When added to 100 ml of human milk, the fortified human milk contains about 2 mg HMB per liter.

TABLE XI

| | Amount per | |
|---|---|---|
| Ingredient Name | 1000 Kg | Units |
| Water | Q.S. | |
| Condensed Skim Milk | 360 | Kg |
| Non-Fat Milk Solids | 94.2 | Kg |
| Maltodextrin | 104 | Kg |
| Medium Chain Triglycerides | 46.6 | Kg |
| Whey Protein Concentrate | 43.4 | Kg |
| Potassium Hydroxide 5% | 30 | Kg |
| Potassium hydroxide solids | 1.5 | Kg |
| Calcium Phosphate | 19.5 | Kg |
| Ascorbic Acid | 5.00 | Kg |
| Magnesium Chloride | 2.70 | Kg |
| Potassium Citrate | 1.95 | Kg |
| Potassium Phosphate | 1.90 | Kg |
| Sodium Chloride | 794 | g |
| Soy Lecithin | 609 | g |
| M-Inositol | 500 | g |
| M. Alpina Oil | 630 | g |
| C. Cohnii Oil | 420 | g |
| Niacinamide | 300 | g |
| Zinc Sulfate | 265 | g |
| d-Alpha-Tocopheryl Acetate | 250 | g |
| Choline Chloride | 150 | g |
| Calcium Pantothenate | 130 | g |
| Ferrous Sulfate | 113 | g |
| Magnesium Phosphate | 141 | g |
| Vitamin A Palmitate | 60.0 | g |
| Calcium HMB | 50 | g |
| Cupric Sulfate | 46.5 | g |
| Riboflavin | 40.0 | g |
| Thiamine Hydrochloride | 32.0 | g |
| Pyridoxine Hydrochloride | 17.0 | g |
| Vitamin D3 | 10.0 | g |
| Folic Acid | 4.40 | g |
| Biotin | 2.50 | g |
| Manganese Sulfate | 1.60 | g |
| Phylloquinone | 0.700 | g |
| Cyanocobalamin | 0.120 | g |
| Sodium Selenate | 0.050 | g |
| Sodium Citrate | As needed | |
| Calcium Carbonate | As needed | |

Example 10, which is found in Table XII, is a concentrated liquid human milk fortifier that is useful as a nutritional supplement to add to human milk that is fed to preterm infants starting. The liquid human milk fortifier has a caloric density of 6.85 kcal/5 ml packet. When added to 100 ml of human milk, the fortified human milk contains about 2 mg HMB per liter.

TABLE XII

| | | Amount per | | |
|---|---|---|---|---|
| Ingredient Name | | 1000 lb | | Units |
| Ingredient Water | | Q.S. | | |
| Casein Hydrolysate | | 112.5 | | lb |
| Maltodextrin | | 113.1 | | lb |
| Potassium Hydroxide 5% | | 39.0 | | lb |
| | Potassium Hydroxide solids | | 2.0 | lb |
| Medium Chain Triglyceride Oil | | 19.7 | | lb |
| Tricalcium Phosphate | | 16.0 | | lb |
| Modified Corn Starch | | 12.0 | | lb |
| Soy Oil | | 11.8 | | lb |
| Coconut Oil | | 7.2 | | lb |
| Ascorbic Acid | | 4.4 | | lb |
| Magnesium Chloride | | 3.4 | | lb |
| M. Alpina Oil (ARA) | | 2.6 | | lb |
| Potassium Citrate | | 4.6 | | lb |
| C. Cohnii Oil (DHA) | | 2.3 | | lb |
| Potassium Chloride | | 1.5 | | lb |
| Sodium Chloride | | 371.5 | | g |
| Monoglycerides | | 408.2 | | g |
| Tyrosine | | 365.0 | | g |
| Leucine | | 235.9 | | g |
| M-Inositol | | 170.0 | | g |
| Vitamin premix | | 178.0 | | g |
| | Niacinamide | | 66.8 | g |
| | d-Calcium Pantothenate | | 43.2 | g |
| | Thiamin Hydrochloride | | 11.0 | g |
| | Pyridoxine Hydrochloride | | 10.6 | g |
| | Riboflavin | | 8.6 | g |
| | Folic Acid | | 1.5 | g |
| | Biotin | | 1.3 | g |
| | Cyanocobalamin | | 29.5 | mg |
| | Dextrose | | q.s. | |
| Vitamin ADEK premix | | 160.0 | | g |
| | dl-alpha-tocopheryl acetate | | 111.7 | g |
| | Vitamin A palmitate | | 15.7 | g |
| | Phylloquinone | | 273.5 | mg |
| | Vitamin D₃ | | 46.5 | mg |
| | Coconut Oil | | q.s. | |
| Tryptophan | | 136.5 | | g |
| Choline Chloride | | 133.0 | | g |
| Zinc Sulfate | | 105.0 | | g |
| Gellan Gum | | 99.8 | | g |
| L-Carnitine | | 78.0 | | g |
| Ultra trace and trace mineral premix | | 73.4 | | g |
| | Ferrous sulfate exsiccated | | 31.1 | g |
| | Zinc Sulfate | | 28.0 | g |
| | Copper Sulfate | | 1.1 | g |
| | Manganese sulfate | | 194.5 | mg |
| | Sodium Selenite | | 30.8 | mg |
| | Maltodextrin | | q.s. | |

| | | |
|---|---|---|
| Niacinamide | 62.0 | g |
| Calcium HMB | 50 | g |
| Vitamin D₃ | 7.0 | g |
| Cupric Sulfate | 4.0 | g |
| Lutein | 0.56 | g |
| Beta Carotene | 940 | mg |
| Manganese Sulfate | 700 | mg |
| Potassium Phosphate | as needed | |
| Potassium Hydroxide 45% | as needed | |

Example 11, which is found in Table XIII, is a concentrated liquid protein supplement that is useful as a nutritional supplement to add to human milk that is fed to preterm infants. The liquid protein supplement has a caloric density of 668 kcal/1000 ml. When 6 ml of liquid protein supplement is added to human milk that also was fortified by human milk fortifier then the resulting supplemented and fortified human milk contains about 2 mg HMB per liter.

TABLE XIII

| | Amount per | |
|---|---|---|
| Ingredient Name | 1000 kg | Units |
| Ingredient Water | Q.S. | |
| Casein Hydrolysate | 202.6 | kg |
| Calcium HMB | 2.5 | g |

### EXPERIMENTAL STUDY

A study of neonatal piglets was performed to measure the extent by which HMB affects muscle protein synthesis. The neonatal piglet model was used because of the similarity in its development to that of the human preterm infant and because of the piglet's rapid rate of growth.

Experimental Methods

Overnight fasted neonatal pigs (5-7 days old) were infused with HMB at 0, 20, 100, or 400 μmol·kg⁻¹·hr⁻¹ HMB. Blood plasma concentrations of the following circulating substrates were measured.

HMB was measured using gas chromatography per the method set forth in: Nissen et al., “Analysis of β-Hydroxy-β-methyl Butyrate in Plasma by Gas Exclusion Chromatography and Mass Spectrometry,” Analytical Biochemistry (1990), Vol. 188, 17-19.

Amino acids including leucine, other branched-chain amino acids (BCAA), essential amino acids (EAA), and nonessential amino acids (NEAA) were determined using high pressure liquid chromatography using the method set forth in: Davis TA, “Enhanced response of muscle protein synthesis and plasma insulin to food intake in suckled rats,” Am J Physiol Regul Integr Comp Physiol (1993), Vol. 265, R334-R340.

Alpha-keto acids of branched chain amino acids (i.e., α-ketoisocaproic acid (KIC, the α-keto acid of leucine), α-ketoisovalerate (KIV, the α-keto acid of valine) and α-ketomethylvalerate (KMV, the α-keto acid of isoleucine)) were measured by high pressure liquid chromatography using the method set forth in: Nissen, S. L., “Measurement of branched chain amino acids and branched chain alpha-ketoacids in plasma by high performance liquid chromatography.” J Chromatog (1982), Vol. 232, 170-175.

At the end of the infusion, the piglets were sacrificed and the fractional protein synthesis rates were measured by measuring ³H incorporation into protein fractions after a flooding dose of L[4-³H]phenylalanine using the method set forth in Garlick, P. J., “A rapid and convenient technique for measuring the rate of protein synthesis in tissues by injection of [3H]Phenylalanine,” Biochem J (1980), Vol. 192, 719-723. Activation of translation initiation was measured in the stomach, duodenum, jejunum, colon, pancreas, kidney, brain and skin. The abundance of intracellular proteins involved in signaling of protein synthesis and in processes related to protein degradation was measured in tissue homogenates by immunoblotting using commercially available antibodies.

Data

The data collected using the experimental methods were analyzed by ANOVA for a Completely Randomized Design. When a significant treatment effect was detected, means were compared using the post-hoc Fisher LSD test. Data are presented as least square means±SEM and differences were considered significant at P≦0.10.

1. Circulating Substrates:

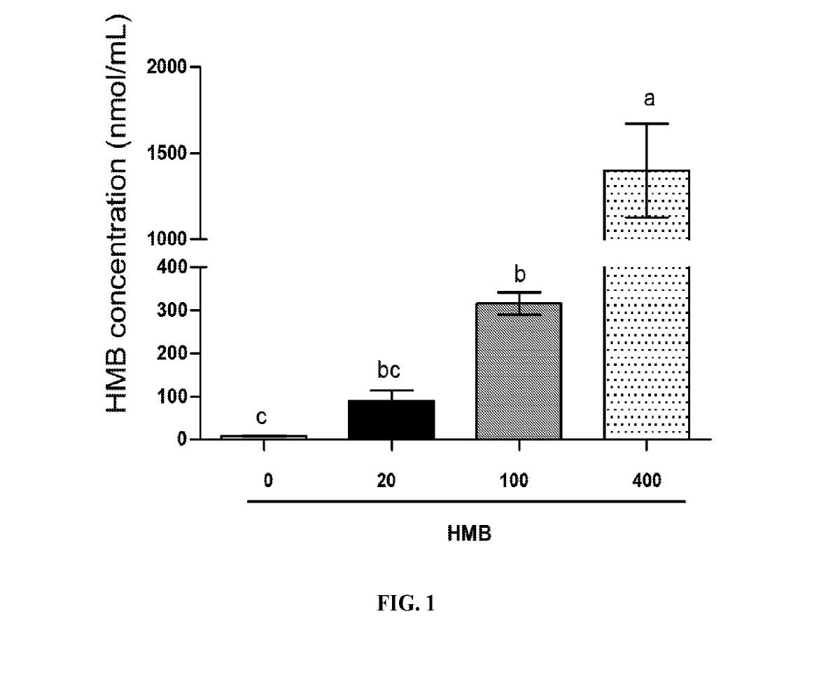

FIG. 1 shows a plot of the blood plasma concentration of HMB vs. the amount of HMB that was infused. Values are presented as means+/−SEM; n=6-7 per treatment. Values not sharing superscripts differ significantly (P<0.5).

As can be seen in FIG. 1, plasma concentrations of HMB achieved were 9, 90, 316, and 1400 nmol·ml⁻¹ in piglets respectively infused with 0, 20, 100, or 400 μmol·kg⁻¹·hr⁻¹ HMB. The plasma concentration of HMB was significantly greater in the piglets infused with 100 and 400 μmol·kg⁻¹·hr⁻¹ HMB as compared to the HMB baseline group (i.e., those piglets infused with 0 μmol·kg⁻¹·hr⁻¹ HMB).

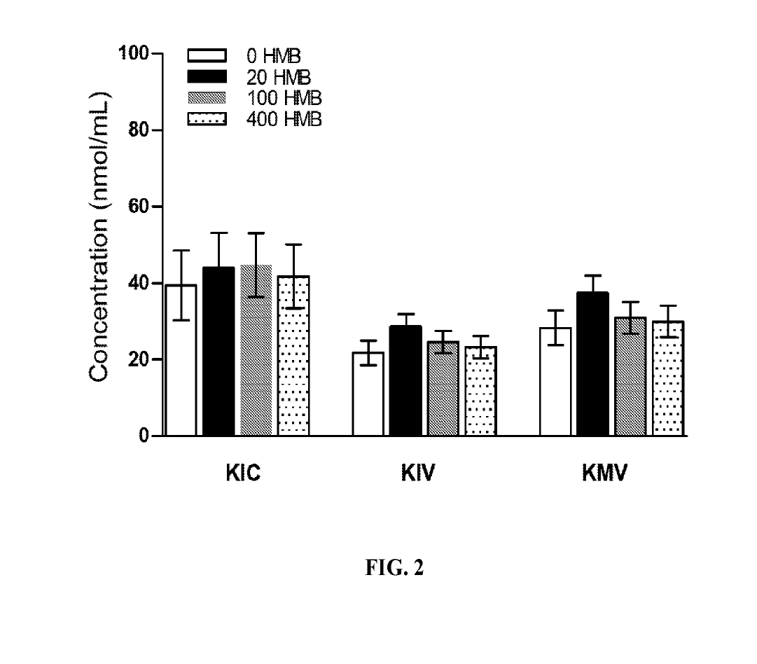

FIG. 2 shows a plot of the of plasma concentration (nmol/mL) of α-ketoisocaproic acid (KIC, the α-keto acid of leucine), α-ketoisovalerate (KIV, the α-keto acid of valine) and α-ketomethylvalerate (KMV, the α-keto acid of isoleucine) in piglets infused with 0, 20, 100 or 400 μmol·kg⁻¹·hr⁻¹ HMB. Values are means+/−SEM; n=6-7 per treatment. Values within each plasma α-keto acid grouping not sharing superscripts differ significantly (P<0.05).

As can be seen in FIG. 2, the infusion of HMB had no impact on the circulating concentrations of KIC, KIV and KMV.

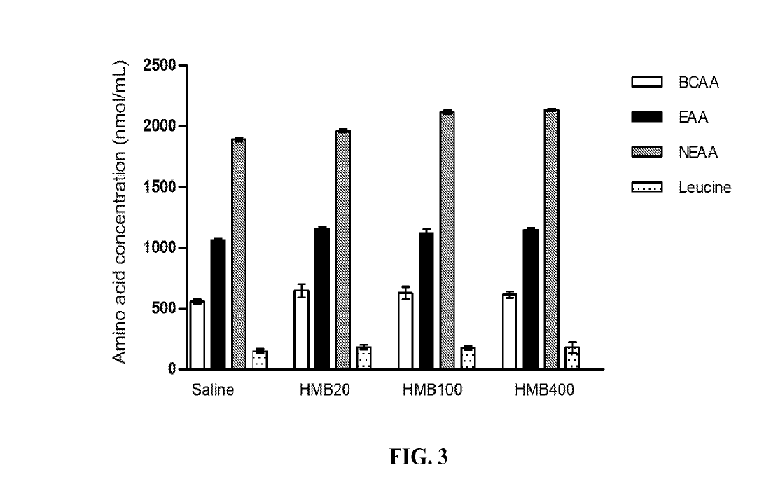

FIG. 3 shows a plot of plasma BCAA, EAA, NEAA and leucine concentrations (nmol amino acid per mL of plasma) in piglets infused with 0, 20, 100 or 400 μmol·kg⁻¹·hr⁻¹ HMB or 400 μmol·kg⁻¹·hr⁻¹ leucine for one hour. The values are means+/−SEM; n=6-7 per treatment. Values within each amino acid grouping not sharing superscripts differ significantly (P<0.05).

As can be seen in FIG. 3, the circulating concentration of HMB had no effect on the concentrations of leucine, BCAA, EAA or NEAA.

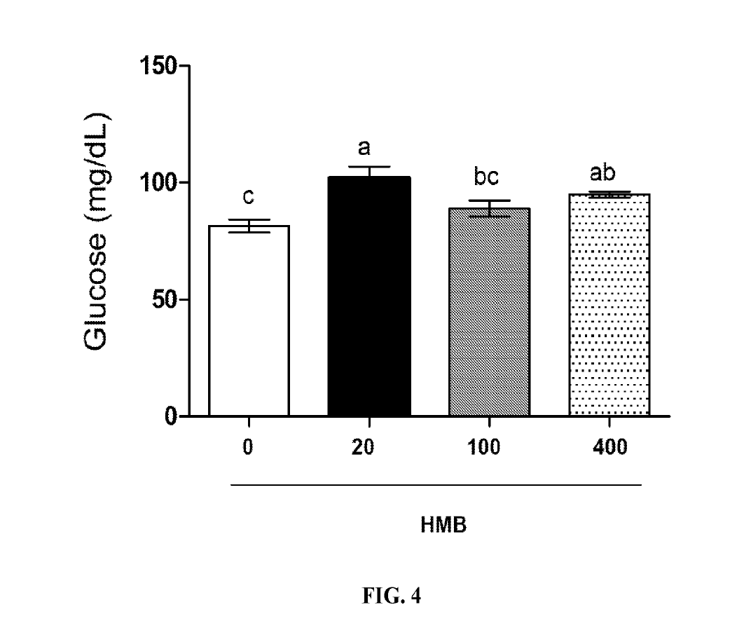

FIG. 4 shows a plot of plasma glucose concentrations in piglets infused with 0, 20, 100 or 400 μmol·kg⁻¹·hr⁻¹ HMB for one hour. Values are means+/−SEM; n=6-7 per treatment. Values for each HMB dosage not sharing superscripts differ significantly (P<0.05).

As shown in FIG. 4, the plasma glucose concentrations were modestly, but significantly (P<0.5), increased by infusion of 20 and 400 μmol·kg⁻¹·hr⁻¹ HMB for one hour.

2. Protein Synthesis:

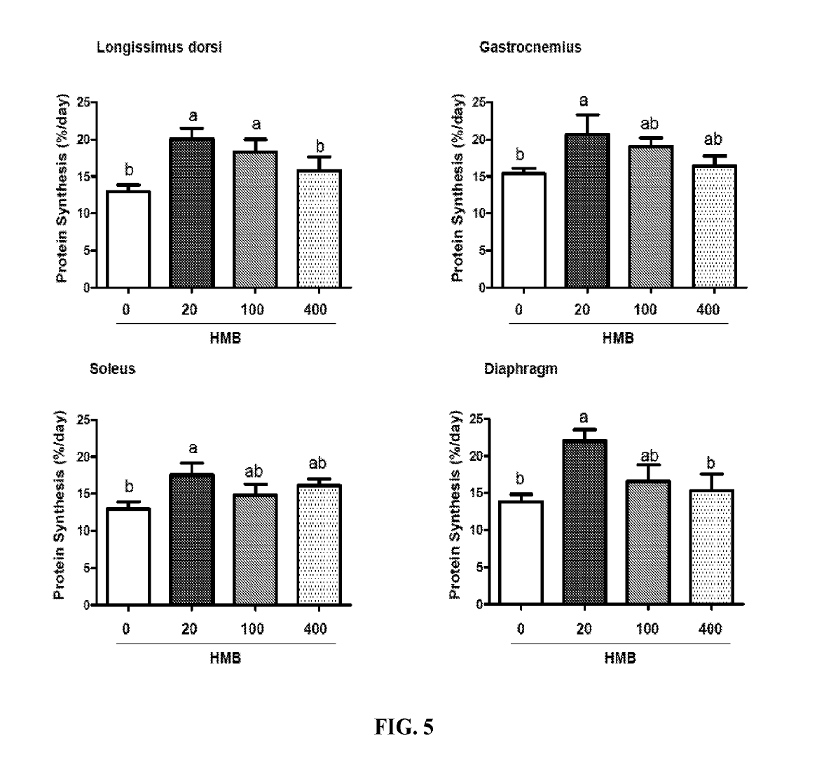

FIG. 5 shows a plot of the fractional rate of protein synthesis in skeletal muscles, specifically the longissimus dorsi, gastrocnemius, soleus, and diaphragm, of piglets infused with 0, 20, 100 or 400 μmol·kg⁻¹·hr⁻¹ HMB for one hour. Values are means+/−SEM; n=6-7 per treatment. Values within HMB infusion grouping not sharing superscripts differ significantly (P<0.05).

As can be seen in FIG. 5, infusion of 20 μmol·kg⁻¹·hr⁻¹ HMB increased (P<0.05) the fractional rates of protein synthesis in the skeletal muscles, specifically, the longissimus dorsi muscle, gastrocnemius, soleus, and diaphragm. Infusion of 100 μmol·kg⁻¹·hr⁻¹ HMB increased (P<0.05) protein synthesis in the longissimus dorsi muscle, but not significantly in the gastrocnemius, soleus, and diaphragm muscles. Infusion of 400 μmol·kg⁻¹·hr⁻¹ HMB had no significant effect on proteins synthesis in the skeletal muscles.

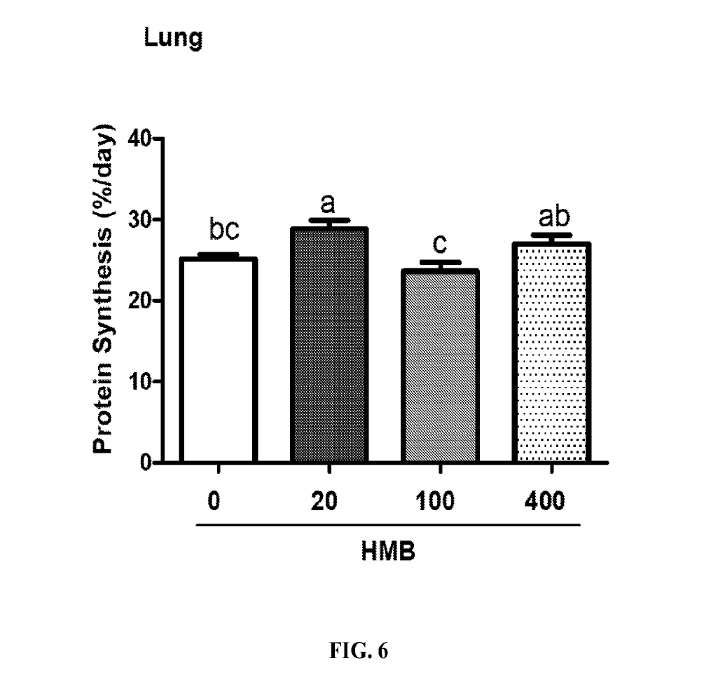

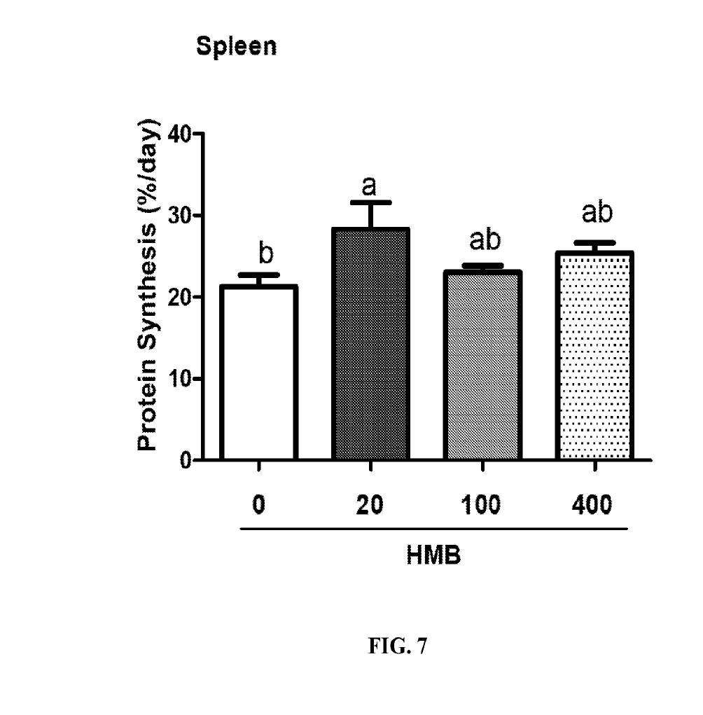

FIGS. 6 and 7 show plots of the fractional rate of protein synthesis in the lung and spleen of piglets infused with 0, 20, 100 or 400 μmol·kg⁻¹·hr⁻¹ HMB for one hour. Values are means+/−SEM; n=6-7 per treatment. Values within HMB infusion grouping not sharing superscripts differ significantly (P<0.05).

As shown in FIGS. 6 and 7, infusion of 20, 100 or 400 μmol·kg⁻¹·hr⁻¹ HMB for one hour increased protein synthesis in the lung and spleen at the infusion rate of 20 μmol·kg⁻¹·hr⁻¹ HMB.

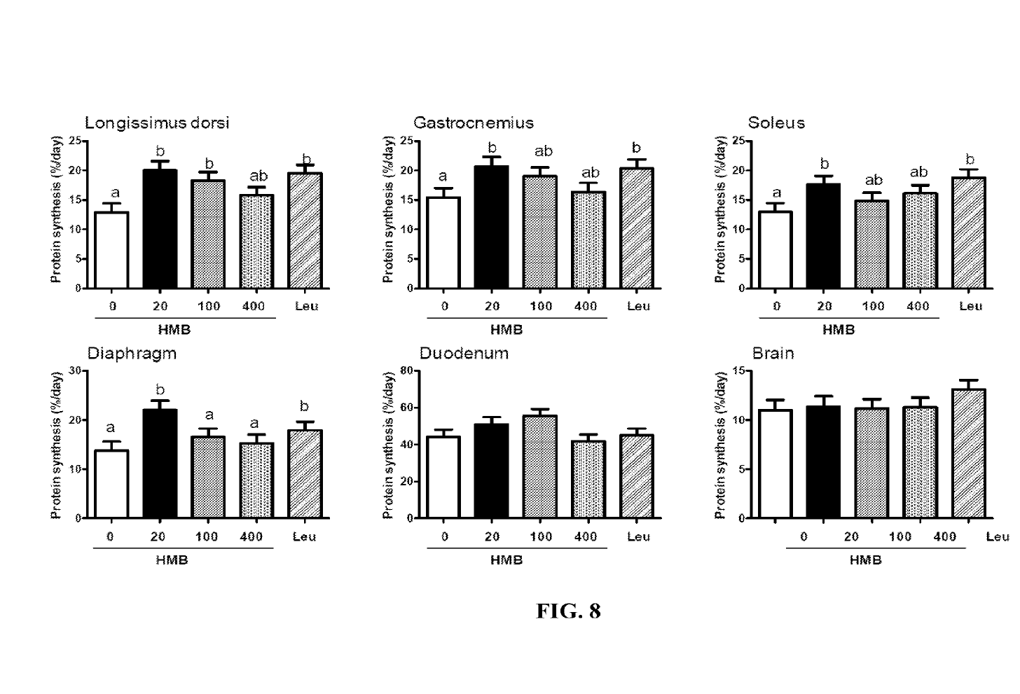

FIG. 8 shows a comparison of protein synthesis rates in the longissimus dorsi, gastrocnemius, soleus, diaphragm, duodenum, and brain of piglets that were infused with HMB at a rate of 0, 20, 100 or 400 μmol·kg⁻¹·hr⁻¹ and leucine at a rate of 400 μmol·kg⁻¹·hr⁻¹.

As shown in FIG. 8, it was surprisingly found that the infusion of HMB was equal to or more effective in increasing protein synthesis than leucine.

3. Intracellular Signaling Components:

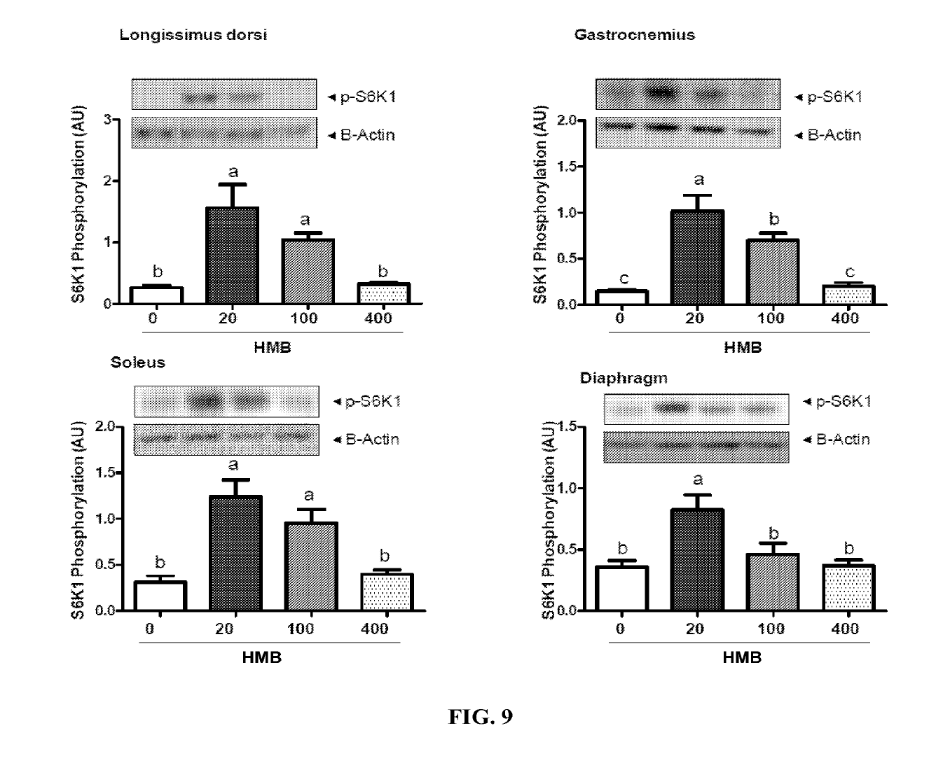

FIG. 9 shows a plot of the phosphorylation of S6K1 in the longissimus dorsi, gastrocnemius, soleus, and diaphragm of piglets infused with 0, 20, 100 or 400 μmol·kg⁻¹·hr⁻¹ HMB for one hour. The phosphorylation of S6K1 is an indicator of mTORC1 signaling to translation.

As shown in FIG. 9, infusion of 20 and 100 μmol·kg⁻¹·hr⁻¹ HMB for one hour increased the phosphorylation of S6K1 in the longissimus dorsi, gastrocnemius and soleus. Infusion of 20, but not 100, μmol·kg⁻¹·hr⁻¹ HMB for one hour increased phosphorylation of S6K1 in the diaphragm. Values are means+/−SEM; n=6-7 per treatment. Values within HMB infusion grouping not sharing superscripts (a,b) differ significantly (P<0.05) for the longissimus dorsi and (P<0.10) for other tissues.

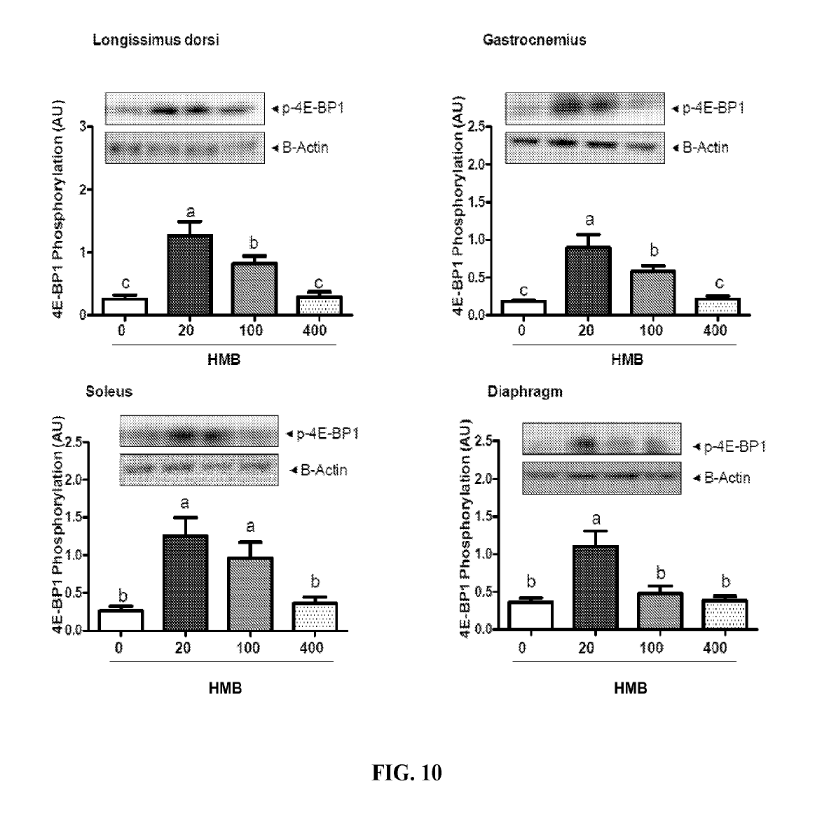

FIG. 10 shows a plot of the phosphorylation of 4EBP1 in the longissimus dorsi, gastrocnemius, soleus, and diaphragm of piglets infused with 0, 20, 100 or 400 μmol·kg⁻¹·hr⁻¹ HMB for one hour. The phosphorylation of 4EBP1 is an indicator of mTORC1 signaling to translation.

As shown in FIG. 10, infusion of 20 and 100 μmol·kg⁻¹·hr⁻¹ HMB for one hour increased the phosphorylation of 4EBP1 in the longissimus dorsi, gastrocnemius, and soleus. Infusion of 20, but not 100, μmol·kg⁻¹·hr⁻¹ HMB for one hour increased phosphorylation of 4EBP1 in the diaphragm.

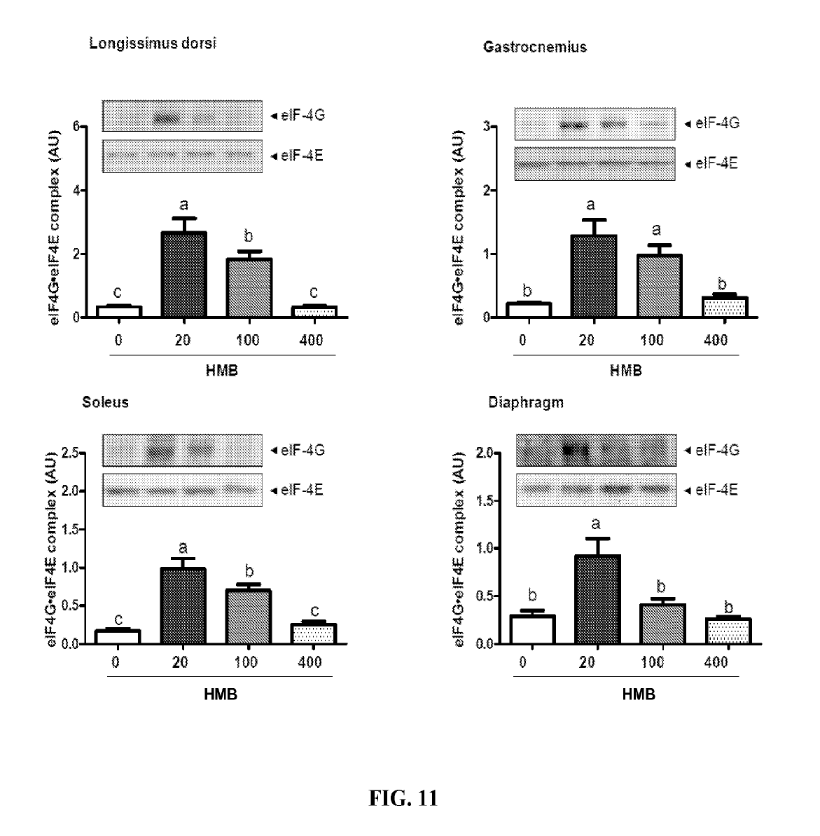

FIG. 11 shows a plot of the formation of the active e1F4E•e1F4G complex in the longissimus dorsi, gastrocnemius, soleus and diaphragm of piglets infused with 0, 20, 100 or 400 μmol·kg⁻¹·hr⁻¹ HMB for one hour. The formation of the active e1F4E•e1F4G complex is an indicator of mTORC1 signaling to translation.

As shown in FIG. 11, infusion of 20 and 100 μmol·kg⁻¹·hr⁻¹ HMB for one hour increased the phosphorylation of 4EBP1 in the longissimus dorsi, gastrocnemius and soleus. Infusion of 20, but not 100, μmol·kg⁻¹·hr⁻¹ HMB for one hour increased phosphorylation of 4EBP1 in the diaphragm.

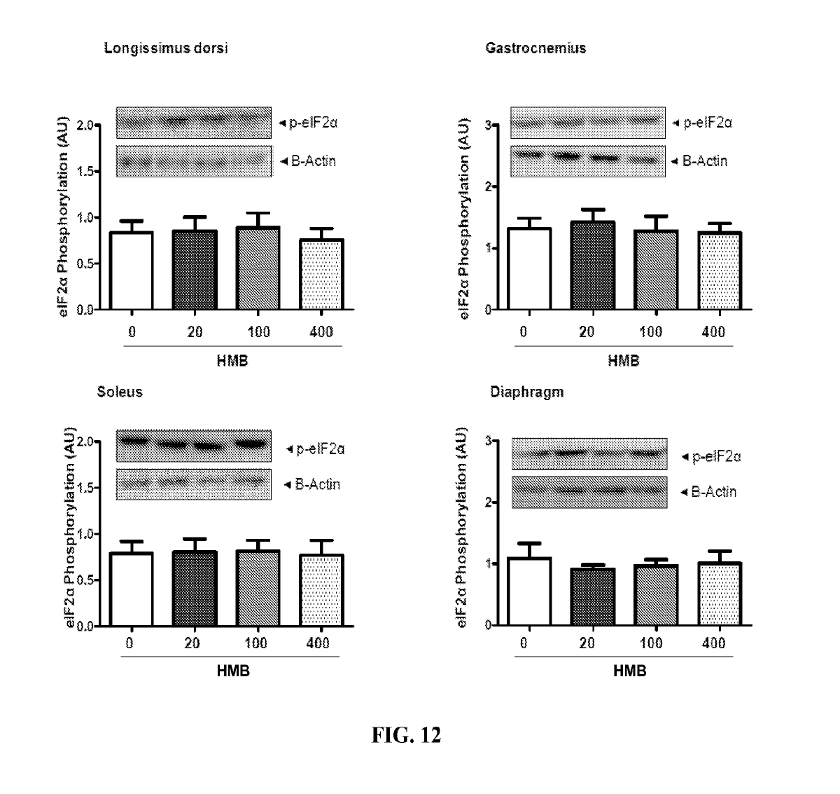

FIG. 12 shows a plot of the phosphorylation of elF2α in the longissimus dorsi, gastrocnemius, soleus and diaphragm of piglets infused with 0, 20, 100 or 400 μmol·kg⁻¹·hr⁻¹ HMB for one hour. The formation of phosphorylation of elF2α regulates tRNA-ribosome binding.

As shown in FIG. 12, infusion of 20 and 100 μmol·kg⁻¹·hr⁻¹ HMB for one hour did not affect the phosphorylation of elF2a.

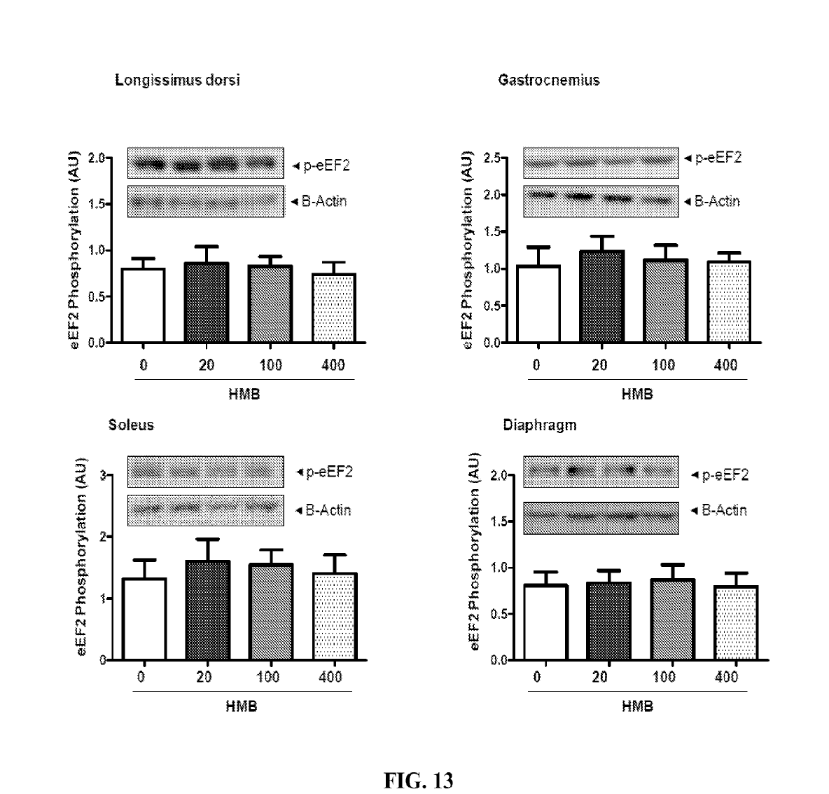

FIG. 13 shows a plot of the phosphorylation of eEF2 in the longissimus dorsi, gastrocnemius, soleus, and diaphragm of piglets infused with 0, 20, 100 or 400 μmol·kg⁻¹·hr⁻¹ HMB for one hour. The formation of phosphorylation of eEF2 regulates tRNA-ribosome binding.

As shown in FIG. 13, infusion of 20 and 100 μmol·kg⁻¹·hr⁻¹ HMB for one hour did not affect the phosphorylation of eEF2.

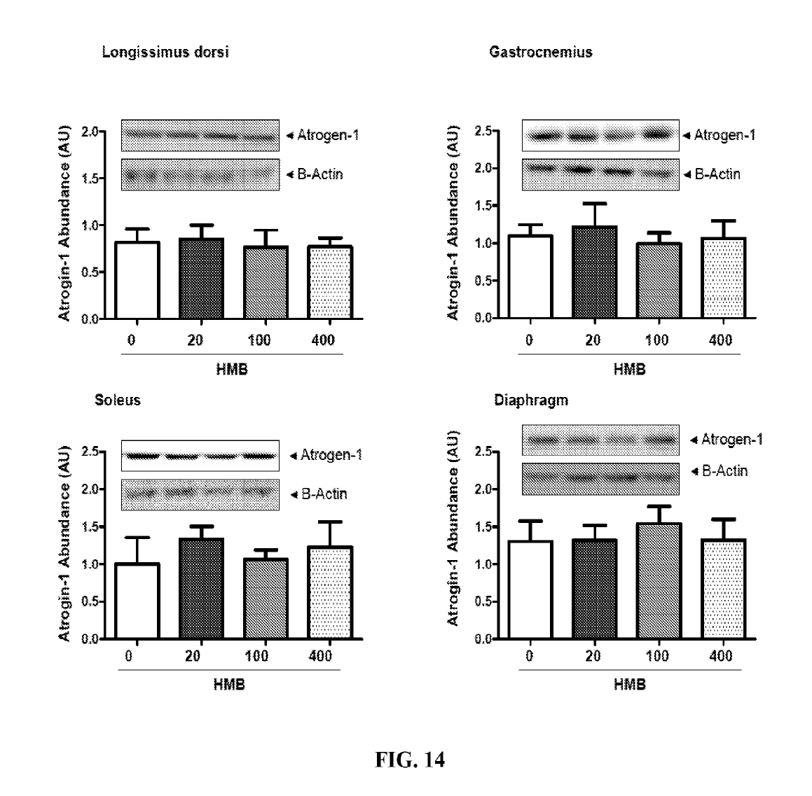

FIG. 14 shows a plot of the expression of Atrogin-1 in the longissimus dorsi, gastrocnemius, soleus and diaphragm of piglets infused with 0, 20, 100 or 400 μmol·kg⁻¹·hr⁻¹ HMB for one hour. Atrogin-1 is a muscle-specific ubiquitin ligase.

As shown in FIG. 14, infusion of 20 and 100 μmol·kg⁻¹·hr⁻¹ HMB for one hour did not affect the expression of Atrogin-1.

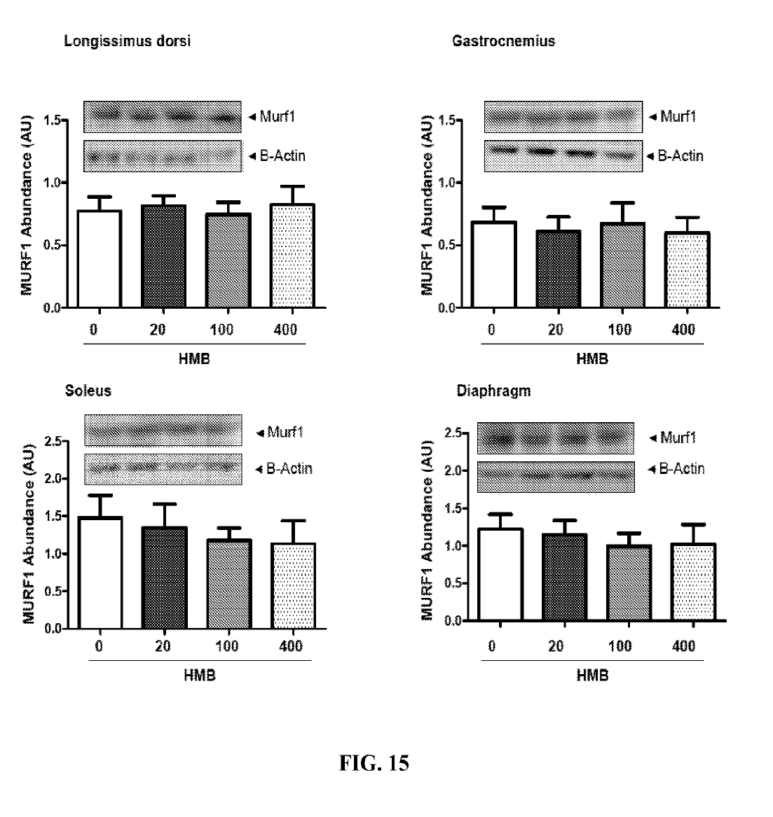

FIG. 15 shows a plot of the expression of MURF1 in the longissimus dorsi, gastrocnemius, soleus and diaphragm of piglets infused with 0, 20, 100 or 400 μmol·kg⁻¹·hr⁻¹ HMB for one hour. MURF1 is a muscle-specific ubiquitin ligase.

As shown in FIG. 15, infusion of 20 and 100 μmol·kg⁻¹·hr⁻¹ HMB for one hour did not affect the expression of MURF1.

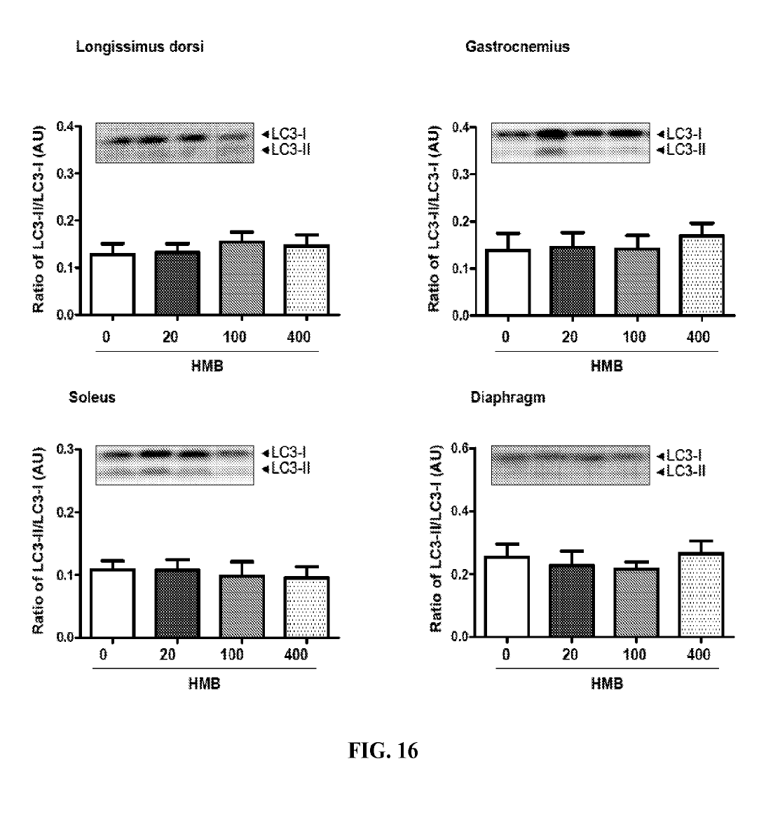

FIG. 16 shows a plot of the ratio of LC3-II/LC3-I in the longissimus dorsi, gastrocnemius, soleus and diaphragm of piglets infused with 0, 20, 100 or 400 μmol·kg⁻¹·hr⁻¹ HMB for one hour. The ratio of LC3-II/LC3-I is an indicator of autophagy/lysosomal protein degradation.

As shown in FIG. 16, infusion of 20 and 100 μmol·kg⁻¹·hr⁻¹ HMB for one hour did not affect the ratio of LC3-II/LC3-I.

Analysis

These data demonstrate that HMB activated protein synthesis by inducing mTORC1. Unexpectedly, HMB did not affect markers of protein degradation or the level of amino acid transporters. The observation that HMB did not affect markers of protein degradation is important because nutritional products for preterm infants should not interfere with protein degradation, which is required for normal development of all tissues. These data are particularly surprising given that it is well established that HMB attenuates protein degradation in the muscles of adults. See for example: Smith, Helen J., “Mechanism of the Attenuation of Proteolysis-Inducing Factor Stimulated Protein Degradation in Muscle by β-Hydroxy-β-Methylbutyrate,” Cancer Research (2004), Vol. 64, 8731-8735; and Smith, Helen J., “Attenuation of Proteasome-Induced Proteolysis in Skeletal Muscle by β-Hydroxy-β-Methylbutyrate in Cancer-Induced Muscle Loss,” Cancer Research (2005), Vol. 65, 277-283. Thus, the present discovery is highly unexpected.

Furthermore, the data surprisingly show that the effect of HMB on protein synthesis was not proportional to the level of HMB intake. For example, the lowest dose of HMB 20 μmol·kg⁻¹·hr⁻¹, had the greatest impact on protein synthesis, whereas the highest dose, 400 μmol·kg⁻¹·hr⁻¹ had the least impact on protein synthesis in four muscles that represent fast twitch, slow twitch, voluntary, and involuntary muscle types. Therefore, there is a discrete range of HMB intake that promotes protein synthesis in neonates.

Additionally, the data surprisingly show that HMB is as effective as leucine in promoting protein synthesis in neonates.

1. A liquid preterm infant nutritional composition comprising from about 60 μg to about 6,000 mg of beta-hydroxy-beta-methylbutyric acid per liter of the composition, the composition having an energy density of from about 676 kcal to about 1014 kcal per liter.

2. The preterm infant nutritional composition according to claim 1, wherein the composition is selected from the group of: liquid infant formula; liquid human milk fortifier; and liquid protein supplement.

3. The preterm infant nutritional composition according to claim 1, wherein the beta-hydroxy-beta-methylbutyric acid is in a form selected from: free acid; salt; anhydrous salt; ester; lactone; and mixtures thereof.

4. The preterm infant nutritional composition according to claim 3, wherein the beta-hydroxy-beta-methylbutyric acid is a beta-hydroxy-beta-methylbutyric acid salt selected from: calcium salt; sodium salt; potassium salt; magnesium salt; chromium salt; and mixtures thereof.

5. The preterm infant nutritional composition according to claim 1, comprising protein in an amount from about 15 grams to about 35 grams of protein per liter of the composition.

6. The preterm infant nutritional composition according to claim 1, comprising protein in an amount from about 18 grams to about 32 grams of protein per liter of the composition.

7. The preterm infant nutritional composition according to claim 2, wherein the composition is a liquid human milk fortifier having an energy density of from about 2 kcal to about 10 kcal per 5 mL of the fortifier.

8. The preterm infant nutritional composition according to claim 2, wherein the composition is a liquid protein supplement comprising an energy density of from about 2 kcal to about 10 kcal per 6 mL of the supplement.

9. A method for promoting protein synthesis, promoting growth and accretion of lean body mass, or both in a preterm infant, the method comprising the step of administering to the preterm infant a preterm infant nutritional composition comprising from about 60 μg to about 6,000 mg beta-hydroxy-beta-methylbutyric acid, wherein the preterm infant nutritional composition has an energy density of from about 676 kcal to about 1014 kcal per liter.

10. The method of claim 9, wherein the preterm infant nutritional composition is selected from the group of: liquid infant formula; liquid human milk fortifier; and liquid protein supplement.

11. The method of claim 10, further comprising the step of preparing the preterm infant nutritional composition by reconstituting a nutritional powder comprising beta-hydroxy-beta-methylbutyric acid.

12. The method of claim 11, wherein the weight percentage of the beta-hydroxy-beta-methylbutyric acid in the nutritional powder is from about 0.000004% to about 25% by weight of the nutritional powder.

13. The method of claim 11, wherein the weight percentage of the beta-hydroxy-beta-methylbutyric acid in the nutritional powder is from about 0.01% to about 10% by weight of the nutritional powder.

14. The method of claim 9, wherein the preterm infant nutritional composition comprises protein in an amount of from about 15 grams to about 35 grams of protein per liter of the composition.

15. The method of claim 9, wherein the preterm infant nutritional composition comprises protein in an amount of from about 18 grams to about 32 grams of protein per liter of the composition.

16. The method of claim 9, wherein the preterm infant nutritional composition is administered to the preterm infant orally or parenterally.
